(19) United States
(12) Patent Application Publication
(10) Pub. No.: US 2007/0240064 A1
(43) Pub. Date: Oct. 11, 2007

(54) Content processing device, change information generating device, content processing method, change information generating method, control program and storage medium

(75) Inventors: Masaki Hashiura, Soraku-gun (JP); Hideyuki Otokawa, Yoshino-gun (JP); Kiyotaka Kashito, Kobe-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/783,367

(22) Filed: Apr. 9, 2007

(30) Foreign Application Priority Data
Apr. 10, 2006 (JP) 2006-107964

(51) Int. Cl. G06F 3/00; G06F 3/048

(52) U.S. Cl. 715/744; 715/788

(57) ABSTRACT

A digital television of the present invention includes: (i) a change pattern list generating section for generating change pattern list representing a list of change patterns applicable to a content, in accordance with change pattern information indicating the change patterns; (ii) a change information acquiring section for acquiring, from outside, change information that defines a change procedure of changing the reproduction object and that corresponds to a change pattern designated by a user from the change patterns included in the change pattern list; and (iii) a change information combining section for changing the content in accordance with the change procedure defined by the acquired change information. This makes it possible to restrain (i) loads on communication lines or (ii) communication cost and to reproduce a customized content meeting a user's diverse needs.

This Nonprovisional application claims priority under 35 U.S.C. § 119(a) on Patent Application No. 2006/107964 filed in Japan on Apr. 10, 2006, the entire contents of which are hereby incorporated by reference.

### FIELD OF THE INVENTION

The present invention relates to a content processing device for processing a received content, and in particular to a content processing device for customizing a content for each user.

### BACKGROUND OF THE INVENTION

Development of communication techniques in recent years makes digital broadcasting and broadband communication pervasive. Such digital broadcasting and broadcasting communication allow large volume contents to be distributed at a high speed. Especially, as to methods of distributing multimedia contents, the following methods are used at the same time: (1) a broadcasting method (PUSH type distributing method) of providing common contents to all the users via one-way communication; and (2) a distributing method (PULL type distributing method) by which a user can operate to acquire a desired content via two-way communication using the Internet. Recent televisions and personal computers are capable of outputting both (i) broadcasting contents acquired in accordance with the broadcasting method and (ii) Internet contents acquired via the Internet.

With such a trend, the number of digital contents that the users can acquire via such televisions and/or personal computers is increasing year by year, with the result that preferences to contents are diversified among the users. Accordingly, a strong demand arises in realizing a digital content distribution system allowing distribution of contents customized individually in accordance with such diversified users' preferences.

For example, Publicly Known Citation 1 discloses a broadcasting receiving system in which a receiving end receives a broadcasting content containing a receiving end dependency component content (customized content) to be changed by the receiving end, customizes the receiving end dependency component content for a user, and outputs the customized receiving end dependency component content in synchronism with the broadcasting content. It is described in Publicly Known Citation 1 that the receiving end dependency component content is customized using information acquired via a network.

On the other hand, Publicly Known Citation 2 discloses a two-way communication data broadcasting system in which a personal content (customized content) specific to each viewer (user) and stored in a receiver is displayed on a screen together with a broadcasting program (broadcasting content) from a broadcasting station.

Publicly Known Citation 3 discloses a content transmitting device and a content receiving device, which provide a system for effectively using discarded broadcasting program materials so as to satisfy each user's preferences and desires.

More specifically, in Publicly Known Citation 3, the content receiving device acquires multi-viewpoint video (multi-listening-point audio) data (customized content) corresponding to a main broadcasting image (audio) data (broadcasting content) and received via a network, and accumulates them therein. The content transmitting device defines presentation information, which is used for setting of various types of way of presenting the main broadcasting image (audio) data and the multi-viewpoint video (multi-listening-point audio) data in the receiving end. This allows the viewer to view the content by appropriately combining (switching) the main broadcasting image data and the multi-viewpoint video data.

[Publicly Known Citation 1]

Japanese Unexamined Patent Publication Tokukai 2001-36485 (published on Feb. 9, 2001)

[Publicly Known Citation 2]

Japanese Unexamined Patent Publication Tokukai 2004-193856 (published on Jul. 8, 2004)

[Publicly Known Citation 3]

Japanese Unexamined Patent Publication Tokukai 2005-159592 (published on Jun. 16, 2005)

However, the aforementioned conventional techniques suffer from the following problems.

In the technique of Publicly Known Citation 1, when the receiving end dependency component content is contained in the broadcasting content, the receiving end dependency component content is inevitably customized for the user. Therefore, the technique of Publicly Known Citation 1 is not applicable to viewing setting in which the user can selectively customize the broadcasting content. In other words, the user cannot select whether to customize the broadcasting content, after judging whether or not the broadcasting content should be customized. This is problematic.

In the technique of Publicly Known Citation 2, a correlation is determined in advance among a broadcasting program, a viewer, and a personal content, so that there is no freedom for the viewer to select whether to display a broadcasting program together with a personal content, or select a personal content be displayed together with the broadcasting program. As such, the technique of Publicly Known Citation 2 fails to meet the user's detailed and diverse needs. This is problematic.

The technique of Publicly Known Citation 3 provides the system for providing the data (the multi-viewpoint video data or the like) of the content to be customized, based on a unit at which the content can be reproduced directly. Therefore, a wide range of types of multi-viewpoint video data (multiplicity of data) is prepared so as to meet diverse needs of viewers. In order to meet such diverse needs of viewers, a massive amount of the multi-viewpoint video data needs to be prepared and distributed.

This causes the following problem. That is, the data size of the multiplicity of multi-viewpoint video data is so massive that the multiplicity of multi-viewpoint video data impose loads on communication lines very much when being distributed via a network. Further, much communication cost is not preferable for the viewers. In the meanwhile, consider a case where the multi-viewpoint video data are distributed with the use of broadcasting waves. In this case, channels need to be secured for the types of multi-viewpoint video data, respectively. Hence, the distribution of the multi-viewpoint video data via the broadcasting waves results in shortage of channels. This is unrealistic.

### SUMMARY OF THE INVENTION

An object of the present invention is to provide a content processing device, a change information generating device, a content processing method, a change information generating method, a control program, and a storage medium, each of which allows restraint of loads on communication lines or of communication cost and makes it possible to reproduce a customized content that meets diverse needs of a user.

To achieve the object, a content processing device of the present invention (digital television 100) for processing received contents, each of which includes a reproduction object including information required for reproducing the content, includes: a change pattern list generating section 22 (change pattern list generating means) for generating change pattern list information representing a list of change patterns applicable to the reproduction object, in accordance with change pattern information indicating the change patterns; a change information acquiring section 23 (change information acquiring means) for acquiring, from a change information storage section storing change information, change information that defines a change procedure of changing the reproduction object, and that corresponds to a change pattern designated by a user from the change patterns included in the change pattern list information; and a change information combining section 24 (change means) for changing the reproduction object in accordance with the change procedure defined by the change information acquired by the change information acquiring section 23.

To achieve the object, a method according to the present invention for processing received contents, each of which includes a reproduction object including information required for reproducing the content, includes: a first step of generating change pattern list information representing a list of change patterns applicable to the reproduction object, in accordance with change pattern information indicating the change patterns; a second step of acquiring, from a change information storage section storing change information, change information that defines a change procedure of changing the reproduction object, and that corresponds to a change pattern designated by a user from the change patterns included in the change pattern list information; and a third step of changing the reproduction object in accordance with the change procedure defined by the change information acquired in the second step.

According to the above structure, the change pattern list generating section 22 generates the change pattern list information representing the list of the one or more change patterns, in accordance with the change pattern list indicating the change patterns, each of which defines how the reproduction object included in the content can be changed.

The change pattern list information can be displayed on a display section. This allows the user to recognize in advance what reproduction object can be changed in what manner.

When the user inputs such a signal as to designate his/her desired change pattern from the change pattern list information, the change information acquiring section 23 specifies the change pattern designated by the user and acquires, from the change information storage section, the change information corresponding to the change pattern. The change information is change information defining the procedure of changing the reproduction object, and is different from medium data that is a reproduction target. Examples of the medium data include the aforementioned personal content and the multi-viewpoint video data.

In accordance with the acquired change information, the change information combining section 24 customizes the reproduction object.

This allows the user to select how the original content is going to be customized, in reference to the change pattern list information. Further, there may be such a change pattern as to indicate that no change is going to be made. By selecting such a change pattern or not, the user can determined whether to change the customizable content.

Further, the change information is information merely specifying the change procedure, and therefore has an information amount much smaller than that of the medium data that is a reproduction target such as the aforementioned personal content and the multi-viewpoint video data. With the use of such change information having the small information amount, the content can be customized as the user desires.

This makes it possible to restrain (i) loads on communication lines or (ii) communication cost, and to provide a customized content meeting the user's diverse needs.

Note that the change pattern information of the reproduction object may be included in the received content. Alternatively, the change pattern information may be acquired independently from the content as long as the change pattern information is correlated with the content ID and the reproduction object ID.

Further, it is preferable that the content be received via a broadcasting wave and the change information be acquired by the change information acquiring section 23 as required.

As such, the information (change information) differing among users is acquired in the manner of the PULL type. This makes it possible to restrain the problems as to the communication time and the communication cost. Further, various types of customized content do not need to be received via broadcasting waves. This makes it possible to restrain the problems as to the shortage of channels and the cost increase in broadcasting equipment.

To achieve the object, a change information generating device according to the present invention for generating the change information to be supplied to the aforementioned content processing device, in response to a request message that is transmitted from the aforementioned content processing device so as to request the change information and that includes (i) a change information ID specifying the change information requested by the content processing device and (ii) the random number generated by the content processing device and correlated with the change information, includes: a definition file database for storing a change information definition file, which defines the change information, such that the change information definition file is correlated with the change information ID; a change information generating section 301 (ID converting means) for extracting, from the definition file database, the change information definition file correlated with the change information ID included in the request message, and for generating the second medium ID in the change definition file by using (i) the first medium ID that specifies the medium object to be reproduced and (ii) the random number included in the request message; and a change information generating section 301 (change information generating means) for generating, as the requested change information, the change information for specifying, in accordance with the second medium ID generated by the change information generating section 301, the storage location of the medium object to be reproduced.

To achieve the object, a method according to the present invention for generating the change information to be supplied to the aforementioned content processing device, in response to a request message that is transmitted from the content processing device so as to request the change information and that includes (i) a change information ID specifying the change information requested by the content processing device and (ii) the random number generated by the content processing device and correlated with the change information, includes: a first step of extracting a change information definition file that defines the change information and that is so stored in a definition file database as to be correlated with the change information ID included in the request message, and of generating the second medium ID in the change definition file by using (i) the first medium ID that specifies the medium object to be reproduced and (ii) the random number included in the request message; and a second step of generating, as the requested change information, the change information for specifying, in accordance with the second medium ID generated by the ID converting means, the storage location of the medium object to be reproduced.

According to the above structure, the change information generating device receives, from the content processing device, the request message for the change information defining the change procedure of changing the reproduction object. The request message includes (i) the change information ID for identifying the change information and (ii) the random number correlated with the change information.

The change information generating device stores the change information definition file such that the change information definition file is correlated with the change information ID. The change information definition file defines the change information, and is a template for the change information. This template is rewritten for the sake of the content processing device having transmitted the request message, with the result that the change information is obtained based on the change information definition file.

Specifically, the change information generating device first extracts, from the definition file database, the change information definition file that is so stored as to be correlated with the change information ID included in the received request message. Then, the change information generating section 301 calculates the second medium ID with the use of (i) the first medium ID that is described in the extracted change definition file and that specifies the medium object to be reproduced, and (ii) the random number included in the request message. The second medium ID is information indicating the storage location of the medium object in the content storage section of the content processing device having requested the change information.

The change information generating section 301 provides, in the change information definition file, the second medium ID generated for the sake of the content processing device, thereby generating the change information requested by way of the request message.

The change information generated in this way is acquired by the content processing device. Accordingly, it is possible to change the reproduction object in accordance with the change procedure described in the change information. The change information is not a reproduction object made up of video data or audio data, but is information indicating a procedure of changing the reproduction object, so that the change information has a data amount smaller than that of the reproduction object.

The change information having such a small data amount is supplied instead of distributing great variety of reproduction objects, so as to change the reproduction object to be reproduced by the content processing device. This makes it possible to reproduce a content that the user desires.

Thus, the present invention makes it possible to restrain either loads on communication line or communication cost, and to reproduce a customized content that meets diverse needs of a user.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 is a block diagram illustrating an arrangement of main parts of a digital television according to an embodiment of the present invention.

FIG. 2 is a block diagram schematically illustrating a structure of the digital television according to the embodiment.

FIG. 3 is an example of a structure of a content to be processed by the digital television of the present invention.

FIG. 4 is a diagram illustrating a concrete example of content information contained in the content.

FIG. 5 is a diagram illustrating a concrete example of a presentation object contained in the content.

FIG. 6 is a diagram illustrating a concrete example of a medium object contained in the content.

FIG. 7 is a diagram illustrating an example how the content is stored in a content storage section of the digital television of the present invention.

FIG. 8 is a diagram illustrating a concrete example of change information acquired by a change information acquiring section of the digital television of the present invention.

FIG. 9 is a diagram illustrating an example of change history information stored in a change history storage section of the digital television of the present invention.

FIG. 10 is a flowchart illustrating a flow of processes in the digital television of the present invention.

FIG. 11 is a flowchart illustrating a flow of a content storage process in which a content managing section of the digital television of the present invention records the acquired content.

FIG. 12 is a flowchart illustrating a flow of a content reproducing process in which a content reproducing section of the digital television of the present invention reproduces the content.

FIG. 13 is a flowchart illustrating a flow of a change information acquiring process in which a change information acquiring section of the digital television of the present invention acquires the change information.

FIG. 14 is a flowchart illustrating a flow of a change history information updating process carried out by the change information acquiring section of the digital television of the present invention after the acquisition of the change information.

FIG. 15 is a flowchart illustrating carried out by a change information combining section of the digital television of the present invention.

FIG. 16 is a diagram illustrating a concrete example of the presentation object with which the change information combining section combines the change information.

FIG. 17 is a diagram illustrating another example of the change information acquired by the change information acquiring section of the digital television of the present invention.

FIG. 18 is a diagram illustrating still another example of the change information acquired by the change information acquiring section of the digital television of the present invention.

FIG. 19 is a diagram illustrating an example of an original content displayed on a display section of the digital television of the present invention.

FIG. 20 is a diagram illustrating an example of a change pattern list displayed on the display section of the digital television of the present invention.

FIG. 21 is a diagram illustrating an example of a customized content displayed on the display section of the digital television of the present invention.

FIG. 22 is a diagram illustrating another example of the change pattern list displayed on the display section of the digital television of the present invention.

FIG. 23 is a diagram illustrating another example of the customized content displayed on the display section of the digital television of the present invention.

FIG. 24 is a diagram illustrating still another example of the customized content displayed on the display section of the digital television of the present invention.

FIG. 25 is a diagram schematically illustrating a content distribution system according to an embodiment of the present invention.

FIG. 26 is a diagram illustrating an example of a change information definition file DB of a change information generating device provided in the content distribution system of the present invention.

FIG. 27(a) is a diagram illustrating a concrete example of a change information definition file, based on which change information is generated.

FIG. 27(b) is a diagram illustrating a concrete example of a change information definition file, based on which change information is generated.

FIG. 27(c) is a diagram illustrating a concrete example of a change information definition file, based on which change information is generated.

FIG. 28 is a diagram illustrating a concrete example of change information generated based on a plurality of change information definition files by a change information generating section of the change information generating device.

### DESCRIPTION OF THE EMBODIMENTS

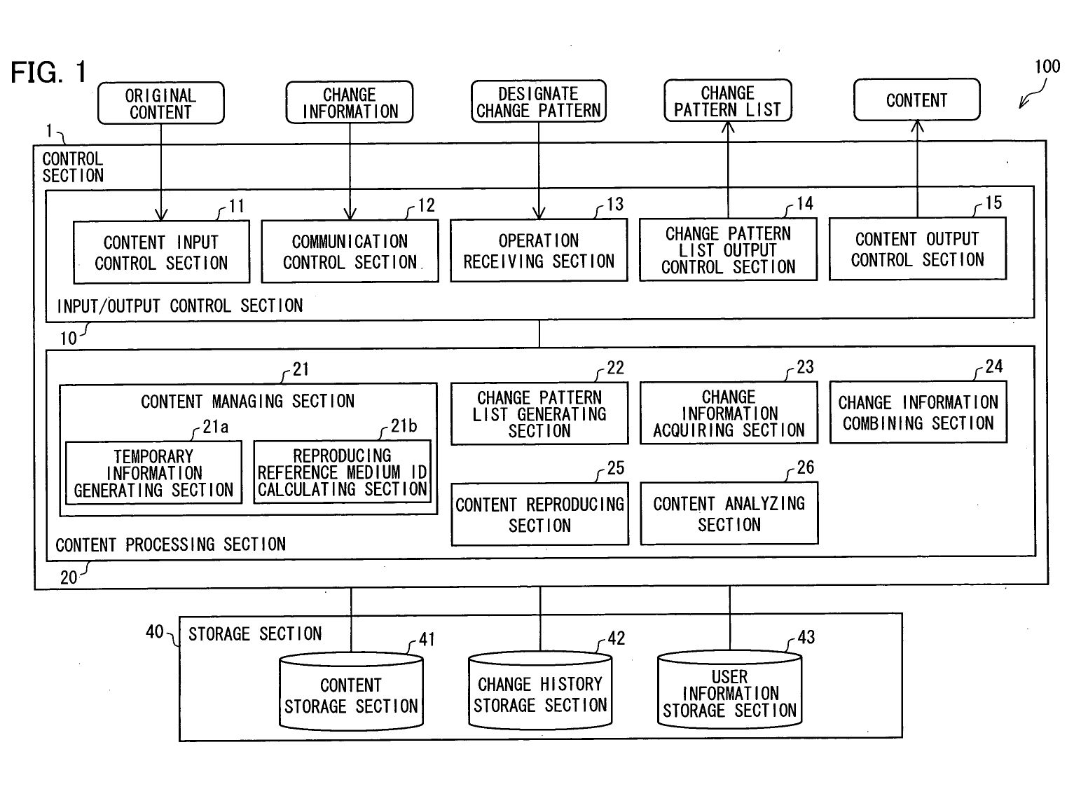

The following explains embodiments of the present invention with reference to FIG. 1 to FIG. 28.

### Embodiment 1

One embodiment of the present invention will be described below with reference to figures. The present embodiment explains, as an example, a case where the content processing device of the present invention is applied to a digital television for receiving terrestrial digital broadcasting.

Assume that the digital television according to the present embodiment is capable of (i) receiving a content (broadcasting program) transmitted from a broadcasting station via a broadcasting wave and/or a content distributed from a content distributor via a communication network, and (ii) accumulating the received content in a storage medium provided in the digital television.

Note that the same members are given the same reference numerals in the figures used in the explanation below. The names and functions thereof are also the same therein. For this reason, detailed explanation for the same members will not be repeated.

(Overview of Digital Television 100)

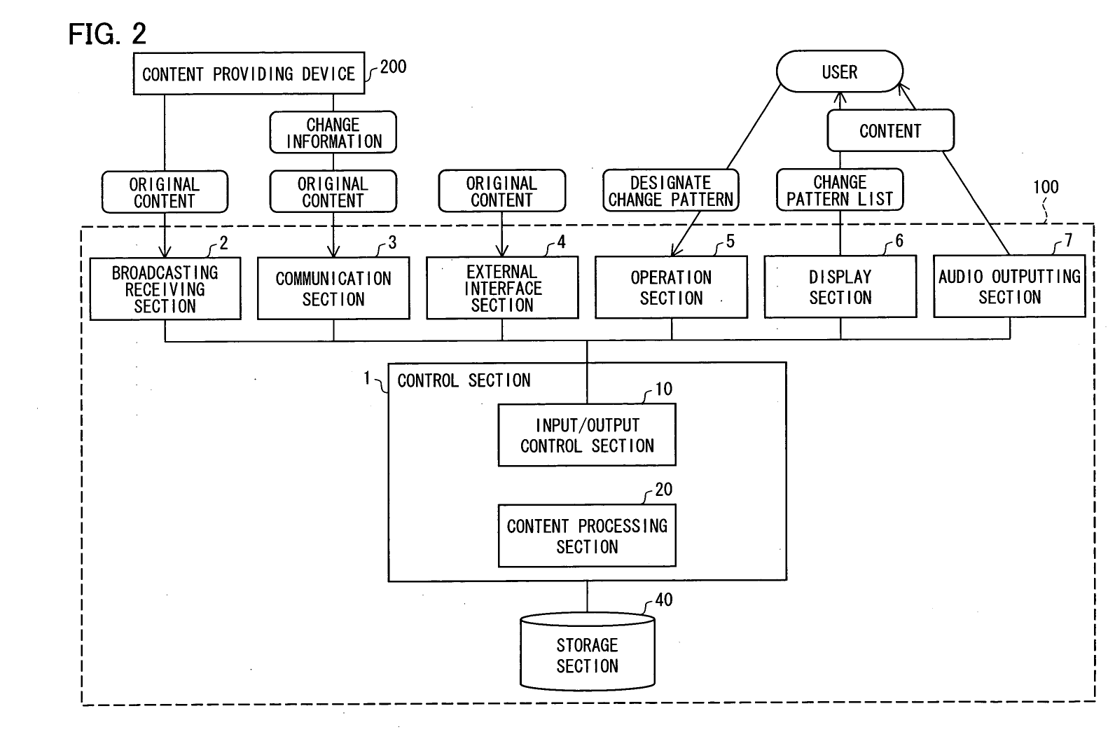

FIG. 2 is a block diagram schematically illustrating a structure of the digital television (content processing device) 100 according to the present embodiment. As shown in FIG. 2, the digital television 100 includes a control section 1, a broadcasting receiving section 2, a communication section 3, an external interface section 4, an operation section 5, a display section 6, an audio outputting section 7, and a storage section 40.

The storage section 40 stores (i) a program to be executed by the control section 1, and (ii) various types of data to be read out when the control section 1 carries out various processes with respect to a content. Example of the various processes includes management of the content, customizing thereof, reproduction thereof, and the like. It is preferable that the storage section 40 be a nonvolatile memory element whose reading/writing speed is relatively fast. Therefore, the storage section 40 is constituted by a flash memory, which is a semiconductor memory medium, or a hard disk, which is a magnetic storage medium. Of course, in cases where the storage section 40 is a volatile semiconductor memory or an optical storage medium whose reading/writing speed is slow, there is no problem for an operation of the digital television 100 serving as the content processing device of the present invention. Details about the control section 1 and the storage section 40 will be described later.

The broadcasting receiving section 2 receives a content transmitted via a broadcasting wave from a content providing device (change information storage section) 200 owned by a broadcasting station. More specifically, for example, the broadcasting receiving section 2 is made up of an antenna, a tuner, a de-multiplexer, and the like. The broadcasting receiving section 2 divides the received content into video data, audio data, and BML (Broadcast Markup Language) data.

The content, which is supplied from the content providing device (change information storage section/change information generating device) 200 and has not been subjected to an individual change process (customizing process) specific to each user of the digital television 100, is hereinafter referred to as “original content” so as to be distinguished from a customized content, which is a content having been subjected to the customizing process. When the original content and the customized content do not need to be distinguished from each other, each of them is simply referred to as “content”. Note that details about the structure of the digital television 100 will be described later.

The communication section 3 receives a content from the content providing device 200 via a communication network realized by the Internet, LAN (local area network), or the like. Data transmission/reception carried out by the communication section 3 is realized by, e.g., IP (Internet Protocol) communication using a wireless communication or a cable broadband communication. The content herein may be distributed in accordance with any distributing method. For example, the content may be distributed in accordance with the multicast method by which one content data is transmitted to a plurality of designated receiving ends, and be received by the communication section 3. Alternatively, the content may be distributed in accordance with the broadcasting method by which one content data is transmitted to unspecified receiving ends, and be received by the communication section 3.

Note that: the communication section 3 receives change information for use in customizing the original content. Details about the change information will be described later.

The external interface section 4 reads out data from an external memory device or a storage medium (change information storage section) such as a DVD, a removable HDD, or a semiconductor memory card, so as to acquire a content and change information each stored in the memory device or the storage medium.

As such, roughly speaking, the contents (or change information) are acquired in the online manner or the offline manner; however, the way of acquiring them is not particularly limited. For example, a content may be acquired in the online manner with the use of a broadcasting wave, a two-way communication path, or both. However, in consideration of (i) capacity of transmission and (ii) communication cost charged on the user for the data acquirement, it is preferable to use the broadcasting wave.

These various types of data such as the contents respectively acquired from the broadcasting receiving section 2, the communication section 3, and the external interface section 4 are recorded onto the storage section 40.

The operation section 5 serves as signal input means to which the user sends a signal so as to cause the digital television 100 to operate. In the present embodiment, the operation section 5 is constituted by, e.g., (i) a remote controller for remotely controlling the digital television 100 from outside of the digital television 100; (ii) operation buttons provided in the digital television 100; and the like. In cases where the operation section 5 is realized as the remote controller, the digital television 100 is a receiving end (light receiving section side) having light receiving means (not shown) for receiving, via light (e.g., an infrared rays), an instruction signal inputted as a result of operating the keys provided in the operation section 5 serving as the remote controller. The instruction signal thus received by the light receiving means is sent to the control section 1.

The display section 6 outputs video (moving image/image) data contained in a content, and is realized by, e.g., a display device such as an LCD (liquid crystal display), a PDP (plasma display panel), or a CRT (cathode-ray tube) display. The audio outputting section 7 is realized as a speaker for outputting audio data contained in the content.

The control section 1 carries out general control over the digital television 100. The control section 1 reads out the various types of program stored in the storage section 40 so as to control the respective sections of the digital television 100 such that the digital television 100 functions as the content processing device of the present invention, thus carrying out the various processes (management of content, customizing thereof, reproduction thereof, and the like). Provided inside the control section 1 are an input/output control section 10 and a content processing section 20.

The input/output control section 10 controls input/output of information between (i) the sections (the broadcasting receiving section 2, the communicating section 3, the external interface section 4, the operation section 5, the display section 6, and the audio outputting section 7) of the digital television 100 and (ii) the content processing section 20 provided in the control section 1.

The content processing section 20 has a function of managing the received content, a function of customizing the original content, a function of acquiring information for use in the customizing, a function of presenting to the user information concerning the customizing, and a function of reproducing the content.

The following explains respective sections of the content processing section 20, and the storage section 40 more in detail.

(Structure of Digital Television 100)

FIG. 1 is a block diagram illustrating an arrangement of main parts of the digital television 100 according to the present embodiment. See FIG. 1. Provided inside the input/output control section 10 of the digital television 100 are a content input control section 11, a communication control section 12, an operation receiving section 13, a change pattern list output control section 14, and a content output control section 15. Provided inside the content processing section 20 are a content managing section (content managing means) 21, a change pattern list generating section (change pattern list generating means) 22, a change information acquiring section (change information acquiring means) 23, a change information combining section (change means) 24, a content reproducing section 25, and a content analyzing section 26. Further, the storage section 40 includes a content storage section 41, a change history storage section 42, and a user information storage section 43.

The content storage section 41 stores contents acquired by the digital television 100. The change history storage section 42 stores history of one or more customizing processes (changes) carried out with respect to each of the contents. The user information storage section 43 stores information (user information) concerning the user.

The user information includes, e.g., identification information of the user, information indicating whether or not the user has a content reproducing right, information indicating whether or not the user has a content change right, and the like. In the present embodiment, the content change right is represented by electronic value information, i.e., points. That is, the number of the points that the user has is recorded onto the user information storage section 43 as the user information. The user uses the points as required in reproducing or changing a content, with the result that the content can be reproduced or changed. The points can be gained by purchasing a commercial product or viewing a broadcasting program.

The content input control section 11 of the input/output control section 10 receives a content received by the broadcasting receiving section 2, the communication section 3, or the external interface section 4. The content thus received is stored in the storage section 40.

The communication control section 12 controls the communication section 3 such that the communication section 3 carries out transmission/reception between the digital television 100 and an external device such as the content providing device 200. More specifically, in cases where, e.g., the user inputs an instruction of downloading change information defining customizing steps (change steps) of customizing a content, the communication control section 12 controls the communication section 3 for the sake of acquiring the change information from the content providing device 200 (FIG. 2).

The operation receiving section 13 receives an instruction signal inputted by the user via the operation section 5 so as to handle a content, and sends the received instruction signal to the content processing section 20. This allows the digital television 100 to carry out a process with respect to the designated content in response to the user's operation.

In the present embodiment, the operation receiving section 13 receives a signal inputted by the user via the operation section 5 and designating a change pattern that the user desires. The wording “change pattern” refers to a type of customizing that can be carried out with respect to a content. Once the change pattern is designated, it is necessary to acquire change information corresponding to the change pattern, so as to customize the content in accordance with the change pattern thus designated. The operation receiving section 13 supplies, to the change information acquiring section 23 for acquiring the change information, the signal designating the change pattern and received from the user.

The change pattern list output control section 14 sends, to the display section 6 in the form of a list, types of customizing applicable to a content, i.e., change patterns. Such a change pattern list (change pattern list information) including one or more change patterns to be displayed is sent from the change pattern list output control section 14 to the display section 6, and the change pattern list is displayed on the display section 6, so that the user can view and recognize the change pattern list thus displayed. This allows the user to recognize how the content can be customized, and to select a desired customizing in cases where there are a plurality of change patterns in the change pattern list. Further, in cases where the change pattern list contains a selection item indicating “perform no customizing”, by selecting the selection item, the user can view a content that is customizable but is not customized.

While the content processing section 20 reproduces a content stored in the storage section 40 or a content acquired from the content providing device 200, the content output control section 15 sends video data (inclusive of image data, moving image data, text data, and the like) of the content to the display section 6, and/or sends audio data thereof to the audio outputting section 7. This allows the user to enjoy the video content displayed on the display section 6, and the music content sent to the audio outputting section 7.

The content managing section 21 of the content processing section 20 stores, in the content storage section 41, contents acquired by the content input control section 11, and manages the contents. The content managing section 21 requests the content analyzing section 26 to analyze each of the acquired contents, and stores the content in the content storage section 41 in accordance with the result of the analysis.

Further, the content managing section 21 may select and read out, from the content storage section 41, a content designated by a content reproducing instruction signal received via the operation receiving section 13.

Further, the content managing section 21 includes a temporary information generating section 21a and a reproducing reference medium ID calculating section 21b. The temporary information generating section 21a generates temporary information to be applied to either a content or partial data of the content when the content is recorded onto the content storage section 41. The temporary information is a random number. The temporary information thus generated is applied to the original data by the reproducing reference medium ID calculating section 21b (ID converting means), with the result that the original data is masked.

It is preferable that the temporary information be generated randomly and have sufficient data length in order to make it difficult to easily conceive a correlation between (i) the (masked) data (or a part of the data) to which the temporary information has been applied and (ii) the original data. This makes it impossible to restore the original content from the masked content or to conceive the masked content from the original content, as long as one does not know the temporary information. Such temporary information is used to restrict a right of using either the content stored in the content storage section 41 or a part of the content. Specifically, by applying the temporary information to the content and recording the content, it is possible to prevent a user with no right of using the content from reproducing the content in the digital television 100, and to prevent illegal use of the content such as illegal copy or unapproved distribution. Details about the reproducing reference medium ID calculating section 21b will be described later.

The change pattern list generating section 22 generates a change pattern list in accordance with change pattern information that is contained in an acquired content and that is applicable to the content. The change pattern list generated by the change pattern list generating section 22 is displayed on the display section 6 by way of the change pattern list output control section 14, with the result that the user views and recognizes the change pattern list. This allows the user to recognize how the content can be customized.

The change information acquiring section 23 acquires change information when the operation receiving section 13 receives a designating signal, which designates a change pattern. The change information is required in customizing the content in accordance with the change pattern designated by the designating signal. Specifically, the change information acquiring section 23 controls the communication control section 12 for the sake of acquiring the change information indicating procedures of changing the content in accordance with the change pattern designated by the designating signal. Under control of the change information acquiring section 23, for example, the communication control section 12 communicates with the content providing device 200, which provides the change information, so as to acquire the designated change information.

If necessary, the change information acquiring section 23 may carry out reading (writing) with respect to the respective storage sections provided in the storage section 40, upon transmitting the request signal for the change information to the content providing device 200. For example, the change information acquiring section 23 may make reference to the change history storage section 42 so as to check what change has been made to the content. Then, in accordance with such a change history, the change information acquiring section 23 may specify change information to be requested. As an alternative example, the change information acquiring section 23 may make a request to the content providing device 200 so as to acquire not only the designated change information but also previous change information that is recorded in the history as “change information having been applied before”. This makes it easy to automatically apply the previous change information in the case of acquiring, in addition to the new change information, the change information having been applied before. Accordingly, the user does not need to always operate to designate the customizing having been designated in the past, all over again.

Alternatively, the change history of the content may be transmitted together with the request signal such that the content providing device 200, which provides the change information, can specify appropriate change information.

Alternatively, the temporary information for the content and the user information may be read out and then be transmitted to the content providing device 200. Details about processes carried out by the change information acquiring section 23 will be described later.

The change information thus acquired by the change information acquiring section 23 is combined with either the content or a part of the content by the change information combining section 24, thereby customizing the content. In the present embodiment, the change information indicating the procedures of changing the content is a so-called patch file. Thus, the change information combining section 24 carries out a patch process with respect to the change target read out from the content storage section 41, in accordance with (i) the result of analysis on the content and (ii) information that is contained in the change information and that indicates the change target. By deleting description per line from the data of the content or inserting description per line thereto, the content can be changed. Such a changed (customized) content is analyzed by the content analyzing section 26 and is reproduced by the content reproducing section 25.

The content reproducing section 25 reproduces the content read out from the content storage section 41 by way of the content managing section 21. The content reproducing section 25 requests the content analyzing section 26 to analyze the readout content and reproduces the content in accordance with the result of the analysis on the content. Procedures of reproducing the content will be described later more concretely.

The content analyzing section 26 analyzes a content when the content managing section 21 causes storing of the content, when the change information combining section 24 customizes the content, and when the content reproducing section 25 reproduces the content. The analysis is carried out in response to instructions made from the aforementioned sections. Specifically, the content analyzing section 26 extracts (i) a structure of the content, (ii) meta information described in the content, (iii) layout information described therein, (iv) medium object reproducing setting, and the like, carries out semantic analysis with respect to each of them, and sends the result of the analysis to the sections having made the instructions for the analysis, respectively.

In the present embodiment, the content analyzing section 26 carries out the lexical analysis for the sake of each of the content managing section 21, the change information combining section 24, and the content reproducing section 25. In other words, one content analyzing section 26 is shared by these sections. However, the present invention is not limited to this. For example, the content managing section 21, the change information combining section 24, and the content reproducing section 25 may include content analyzing sections exclusively used for them, respectively. However, the lexical analyses are carried out in the same manner, so that it is possible to more simplify the structure of the content processing section 20 by sharing one content analyzing section 26 with these sections.

Next, the following fully explains a structure of the content to be analyzed by the content analyzing section 26.

(Structure of Content)

(1) Overview of Overall Structure

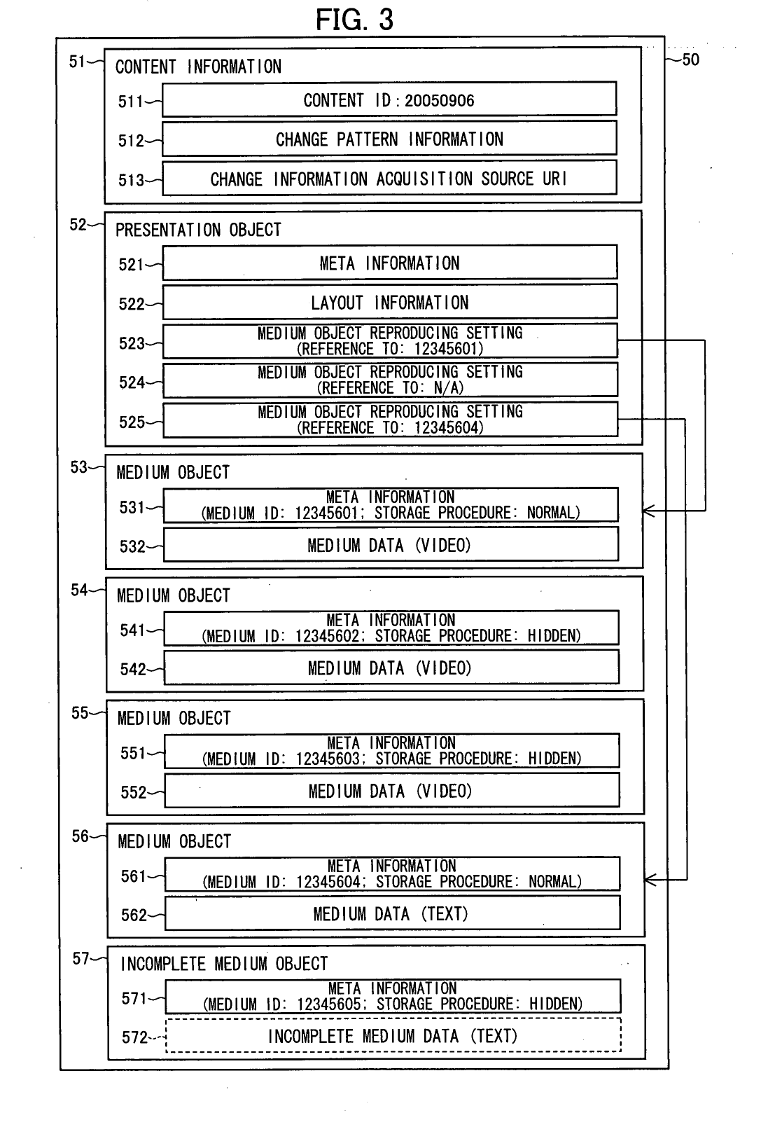

FIG. 3 is a diagram illustrating one example of the structure of the content to be processed by the digital television 100 according to the present invention.

As shown in FIG. 3, such a content 50 includes content information 51, a presentation object 52, and medium objects 53 to 57.

The content information refers to management information for use in managing reproducing of the content and customizing thereof. The presentation object (reproduction object) refers to information defining (i) procedures of reproducing the content and/or (ii) procedures of processing the medium objects (reproduction objects). For example, the presentation object includes information defining a layout, i.e., defining what media objects are respectively positioned on what regions of the display screen of the display section 6. Each of the media objects refers to (i) medium data to which the content reproducing section 25 carries out the reproducing operation, and (ii) information concerning the medium data. The medium data is target data for the reproducing operation. Specific examples thereof are video data, image data, moving image data, audio data, text data, and the like.

Note that the structure of the content 50 shown in FIG. 3 is a mere example, so that the structure of the content processed in the present invention is not limited to this.

(2) Content Information

The content information 51 includes a content ID 511, change pattern information 512, and a change information acquisition source URI (Uniform Resource Identifier) 513. The content ID 511 represents an identifier uniquely specifying the content 50. The change pattern information 512 indicates information concerning change patterns that can be applied to the content 50. The change information acquisition source URI 513 indicates an address of a source from which change information to be combined with the content 50 is to be acquired.

In the present embodiment, the content 50 is given “20050906” as the content ID 511. The content ID is given so as not to coincide with those of other distributed contents.

In the present embodiment, the plurality of objects (the presentation object 52, the medium objects 53 to 57, and the like) are integrated into one data so as to constitute the content 50; however, these objects may be acquired at different timings respectively. In this case, these objects are given the aforementioned content ID “20050906” in the respective content information of the objects such that the objects can be gathered into one data.

The change pattern information 512 is information indicating how the reproduction material (medium object) in the content 50 or the reproducing procedures (presentation object) thereof can be changed (customized). The change pattern information 512 includes change patterns that are respectively given change IDs. Therefore, it is possible to uniquely recognize what each of the change patterns is.

In accordance with such change pattern information 512, the change pattern list generating section 22 generates a change pattern list and presents it to the user.

The change information acquisition source URI 513 is the information indicating the address of the source from which the change information is acquired. It is assumed in the present embodiment that the change information acquisition source URI is, e.g., the URL (Uniform Resource Locator) of the content providing device 200. In reference to such a change information acquisition source URI 513, the change information acquiring section 23 transmits a request thereto for the change information. Note that the change information acquisition source URI 513 is information required in acquiring the change information in the online manner, i.e., via a communication network, so that the change information acquisition source URI 513 is not required in cases where the change information is acquired in the offline manner.

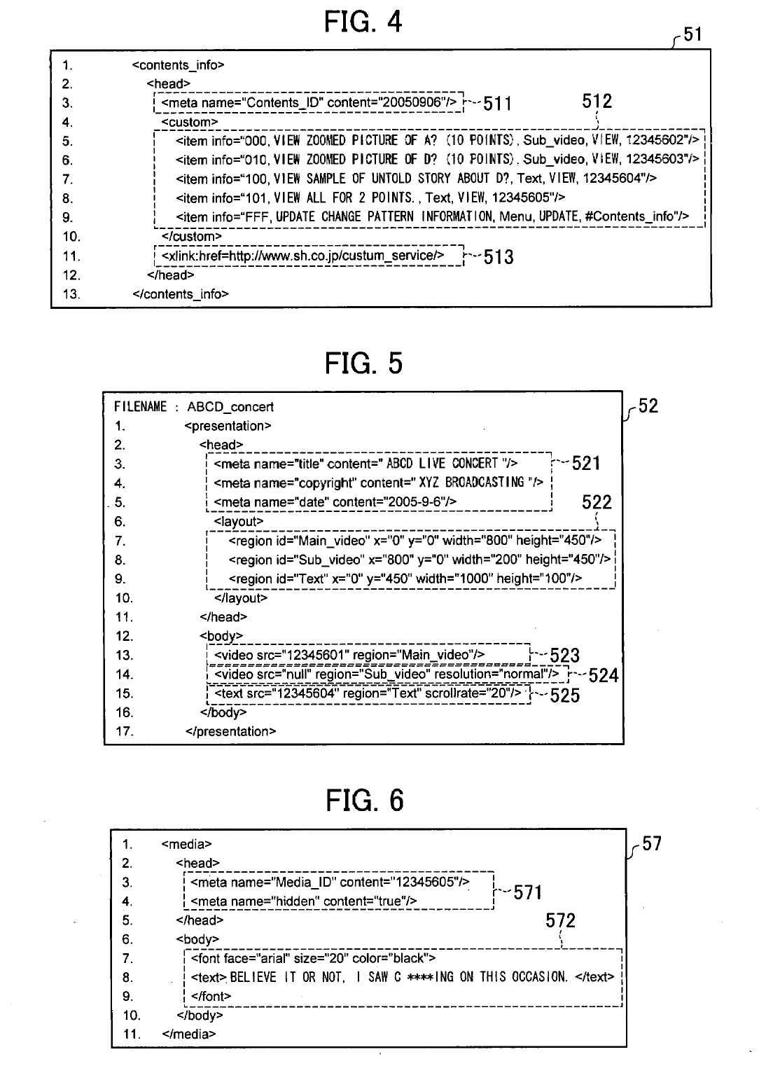

FIG. 4 is a diagram illustrating a concrete example of the content information 51. The third line of such content information 51 describes the content ID 511, and indicates that the content ID 511 is “20050906”.

The fifth line to the ninth line thereof describe the change pattern information 512. One line of the change pattern information 512 corresponds to one change pattern. In the example shown in FIG. 4, each change pattern's attribution is indicated by information (info attribution) made up of five fields respectively sectioned by commas. The fields from left to right respectively indicate a change information ID, a presented material, a presented region, a determination button text, and a correlated medium ID.

The field indicating the change information ID is a field for storing an identifier uniquely specifying change information (managed by the content providing device 200) corresponding to a change pattern that is to be applied to the content. In the present embodiment, for example, the change information ID is constituted by three digits of hexadecimal number.

The field indicating the presented material is a field for storing information defining how the information indicating the change patterns is to be expressed so as to present the change patterns in the form of the change pattern list. In the present embodiment, each of the change patterns is expressed by a letter or a string of letters, so that letters (string of letters) to be actually presented are described in the field as they are. Note that the information stored in this field may indicate each of storage locations of an icon file, a graphic file, an image file, and the like. In this case, the change patterns are expressed by predetermined icons, graphics, images, and the like, thus being presented to the user.

The field indicating the presented region is a field for storing information specifying what region on the screen of the display section 6 (FIG. 2) the change pattern list presenting the change patterns is to be presented. In the present embodiment, for example, the field indicating the presented region defines three regions in the screen of the display section 6: (i) a main display region, (ii) a sub display region, and (iii) a text display region. Thus, the text defined by the field indicating the presented material is designated to be displayed on any one of these three regions.

The field indicating the determination button text is a field for storing information defining what letters are to be displayed on determination buttons to be displayed on display section 6. Each of the determination buttons is realized by displaying a GUI (Graphical User Interface) image on the display section 6. When the user selects such determination buttons, instruction signals for executing various types of process that can be carried out by the digital television 100 are sent to the digital television 100.

For example, when the user selects a determination button correlated with a certain change pattern, the change information acquiring section 23 of the digital television 100 starts to carry out an operation of acquiring a change information including a change information ID correlated with the change pattern.

The field indicating the correlated medium ID is a field for storing an ID of a medium object that is to be influenced by selecting the change pattern and combining the acquired change information with the content.

In accordance with such a change pattern having values in the above fields, the change information is acquired for the purpose of customizing the content. In the present embodiment, the change information to be acquired is specified by the change information ID. In the present embodiment, the change information ID is constituted by several digits of hexadecimal number.

The following explains one example of a rule of issuing the change information ID in cases where the change information ID is set to have a fixed length, i.e., three digits.

The first digit (hundred's digit) indicates a presented region on which the target data to be changed in accordance with the change information is going to be displayed. For example, in cases where the first digit is “2”, the target data is going to be displayed on the main display region. In cases where the first digit is “0”, the target data is going to be displayed on the sub display region. In cases where the first digit is “1”, the target data is going to be displayed on the text display region.

The second digit (ten's digit) (group identifier) indicates a group identifier given to the change information in cases where change information are classified into groups under a predetermined condition. The predetermined condition under which the change information are classified is such a condition that change information that cannot be applied simultaneously to one data are classified into the same group. Specifically, the second digit is used to manage change information to be applied exclusively. Some change information cannot be applied simultaneously to one content (or medium object). In the case of providing such selective change pattern variations, the change patterns are classified into the same group and are given the same group identifier. With this, it is possible to carry out control such that change information having the same group identifier are never applied at the same time.

The third digit (one's digit) indicates respective change levels of change information to be applied to one content. Specifically, consider a case where first change information is applied to a certain content and then second change information is applied to the content thus customized by applying the first change information. In this case, the two change information are applied in two steps. With the first change information expressed as “level 1” and the second change information expressed as “level 2”, it is possible to manage the series of change information to be applied to the content.

Specifically, consider a case where there are two contents A and B that can be reproduced on a certain region 1 and that can be customized in two steps (level 1 and level 2). In this case, a change information ID of the level 1 for the content A is “000”, a change information ID of the level 2 for the content A is “001”, a change information ID of the level 1 for the content B is “010”, and a change information ID of the level 2 for the content B is “011”.

Described in the eleventh line of the content information is the change information acquisition source URI 513. In the example shown in FIG. 4, all the change patterns described in the change pattern information 512 are correlated with the address of one acquisition source. However, the present invention is not limited to this. For example, the change patterns may be correlated with the addresses of acquisition sources, respectively.

(3) Presentation Object

The presentation object 52 (FIG. 3) includes meta information 521, layout information 522, and reproducing setting information 523 to 525. The meta information 521 indicates an attribution of the content 50. The layout information 522 indicates information defining reproduction regions of the medium objects. The reproducing setting information 523 to 525 indicate information defining ways of reproducing the medium objects, respectively. The number of the reproducing setting information 523 to 525 differs among contents, and is not particularly limited. In the present invention, the three reproducing setting information 523 to 525 are prepared and provided in the presentation object 52 so as to correspond to the regions defined by the layout information 522, respectively.

FIG. 5 is a diagram illustrating a concrete example of such a presentation object 52. In the example shown in FIG. 5, the presentation object 52 has a filename “ABCD_concert”. Note that the presentation object 52 may be realized in accordance with a description language such as XML (Extensible Markup Language). More specifically, SMIL (Synchronized Multimedia Integration Language) or BML (Broadcast Markup Language) may be used.

Described in the third line to the fifth line of the presentation object 52 is the meta information 521. The meta information 521 describes the attribution information of the content 50, such as a title, copyright information, or a date on which the content 50 is provided.

Described in the seventh line to ninth line is the layout information 522. Each line corresponds to one display region. In the example shown in FIG. 5, the layout information concerning the display regions is made up of the following five attributions: (1) a region id attribution, (2) an x attribution, (3) a y attribution, (4) a width attribution, and (5) a height attribution. The region id attribution represents each of the display region IDs for identifying the regions defined in the screen of the display section 6. In the present embodiment, display region IDs “main_video”, “Sub_video”, and “text” are respectively given to the main display region, the sub display region, and the text display region, each of which is defined in the screen of the display section 6. The x attribution and the y attribution represent a coordinate of an initial point (e.g., the far upper left with respect to each display region) defining a display point in each of the display regions of the screen of the display section 6. It is assumed here that: the x attribution indicates a vertical position and the y attribution indicates a horizontal position, thereby setting the initial point. The width attribution and the height attribution represent a display size of each of the display regions. The width attribution indicates the width of the display region (the unit of the width is, e.g., dot) and the height attribution indicates the height thereof, thereby setting the size of the display region.

For example, the seventh line of the presentation object 52 indicates that the region (main display region) given the ID “Main_video” is supposed to be displayed, with such a size that the width is 800 dots and the height is 450 dots, on a position determined by setting the x coordinate at 0 and the y coordinate at 0.

Described in the thirteenth line to the fifteenth line of the presentation object 52 are the reproducing setting information 523 to 525. One line corresponds to one reproducing setting information. The reproducing setting information 523 to 525 define what media objects are supposed to be displayed (reproduced) respectively in the display regions defined by the layout information 522, in what manner.

For example, the thirteenth line of the presentation object 52 indicates that the medium object correlated with a medium ID “12345601” is supposed to be reproduced in the region given the display region ID “Main_video” defined in the seventh line of the presentation object 52, i.e., is supposed to be reproduced in the main display region. The fourteenth line of the presentation object 52 indicates that a medium object is supposed to be reproduced, with resolution set at “normal”, in the region (sub display region) given the display region ID “Sub_video” defined in the eighth line of the presentation object 52. However, when reference information (reproducing control information) for the medium object indicates “null”, no medium object is specified to be reproduced, so that nothing is going to be displayed on the sub display region. The fifteenth line of the presentation object 52 indicates that the medium object correlated with a medium ID “12345604” is supposed to be reproduced, at a scroll rate of “20”, in the region (text display region) given the display region ID “Text” defined in the ninth line of the presentation object 52.

As described above, the reproducing setting information 523 to 525 respectively indicate the medium objects to be made reference, so that the content management section 21 can specify and read out the medium objects to be reproduced by the content reproducing section 25.

Note that arrows illustrated in FIG. 3 show how the reproducing setting information 523 to 525 indicate the medium objects to be made reference. The reproducing setting information 523 defines that the medium object correlated with the medium ID “12345601” is supposed to be reproduced. The reproducing setting information 525 defines that the medium object correlated with the medium ID “1234504” is supposed to be reproduced. However, the reproducing setting information 524 specifies no medium object to be made reference. Therefore, at the moment of acquiring the content 50, it is set that the medium objects 54, 55, and 57 are not supposed to be reproduced unless some change (customized process) is made to the reproducing setting information 523 of the content 50.

In other words, by changing a description in each of the reproducing setting information 523 to 525 such that a different medium object is to be made reference, it is possible to switch between reproducing and non-reproducing of a medium object or to change a medium object to be reproduced.

(4) Medium Object

The medium object 53 (FIG. 3) includes meta information 531 and medium data 532. The meta information indicates an attribution of the medium object 53. The medium data 532 are video data, audio data, and the like, which are to be subjected to the reproducing process carried out by the content reproducing section 25. Each of the medium objects 54 to 57 has an identical structure to that of the medium object 53. Therefore, the following explains the structure of the medium object 53. Note that the number of the medium objects contained in the content 50 are not limited to the number (five) described in the example shown in FIG. 3. The number thereof may be any number, i.e., one or more.

The meta information 531 of the medium object 53 includes a medium ID and storage procedure information. The medium ID is used to uniquely identify the medium data 532. The storage procedure information defines storage procedures, i.e., procedures of storing the content in the content storage section 41.

FIG. 3 shows the medium ID and the storage procedure information as the example of the meta information; however, the meta information is not limited to this example. For example, the meta information may include information indicating a data size of the medium data 532.

In the present embodiment, there are two types of procedure indicated by the storage procedure information for the sake of storing the medium data: (i) a “normal storage method” and (ii) a “hidden storage method”. Details about these two storage methods will be explained later.

Meanwhile, in the present embodiment, there are two types of medium data contained in the medium objects 53 to 57: (i) normal medium data and (ii) incomplete medium data. The normal medium data is medium data that is in a complete form in which the medium data should be provided. The incomplete medium data is medium data that is masked such that a part of the data cannot be viewed and/or heard. The medium data illustrated by a frame of broken line in the medium object 57 shown in FIG. 3 is incomplete medium data 572.

FIG. 6 is a diagram illustrating a concrete example of the medium object 57.

Described in the third line and the fourth line of the medium object 57 is the meta information 571. As described above, the meta information 571 includes the medium ID and the storage procedure information. In the example shown in FIG. 6, the aforementioned incomplete medium data 572 has a medium ID “12345605”, and has storage procedure information designating the hidden storage method. The hidden storage method refers to a method by which a content is recorded onto the content storage 41 such that the medium ID of the content is hidden and is therefore inconceivable. The medium ID may be hidden by the content managing section 21 in accordance with temporary information generated by the temporary information generating section 21a, and then the content may be recorded onto the content storage section 41.

Whether to record the medium object 57 thereonto in accordance with the hidden storage method is determined by making reference to the description of the fourth line shown in FIG. 6. The fourth line describes an attribution called “hidden attribution”, and the hidden attribution indicates whether or not the medium data is to be recorded in accordance with the hidden storage method. Specifically speaking, when a value indicative of “true” is described in the content of the hidden attribution, the hidden attribution indicates that the medium data is supposed to be recorded in accordance with the hidden storage method. On the other hand, when a value indicative of “false” is described therein, the medium data is never hidden, i.e., is supposed to be recorded as it is in accordance with the normal storage method. Details about such a storage process will be described later.

Described in the seventh line to the ninth line of the medium object 57 is the incomplete medium data 572. See the eighth line in which a part of the text data is described as “****” Such an expression makes it impossible to fully obtain all the information therefrom. By replacing such an incomplete part described as “****” with corresponding complete data, there is obtained normal data that should have been provided in the first place.

Note that FIG. 6 shows the example in which the incomplete medium data 572 is text data; however, the present invention is not limited to this. For example, the incomplete medium data 572 may be image data. Specifically, consider a case where the incomplete medium data 527 is image data indicative of an image having a part painted in black. Such incomplete image data can be restored to complete image data by customizing the incomplete image data in accordance with change information indicating the corresponding complete image data. In this case, the incomplete image data can be customized by adding or replacing a string of letters in each line of the change information in the same manner as described above.

The content having the above structure is recorded by the content managing section 21 onto the content storage section 41 in accordance with the result of analysis carried out by the content analyzing section 26. The following explains the content storage section 41 onto which the content managing section 21 records the content.

(Content Storage Section)

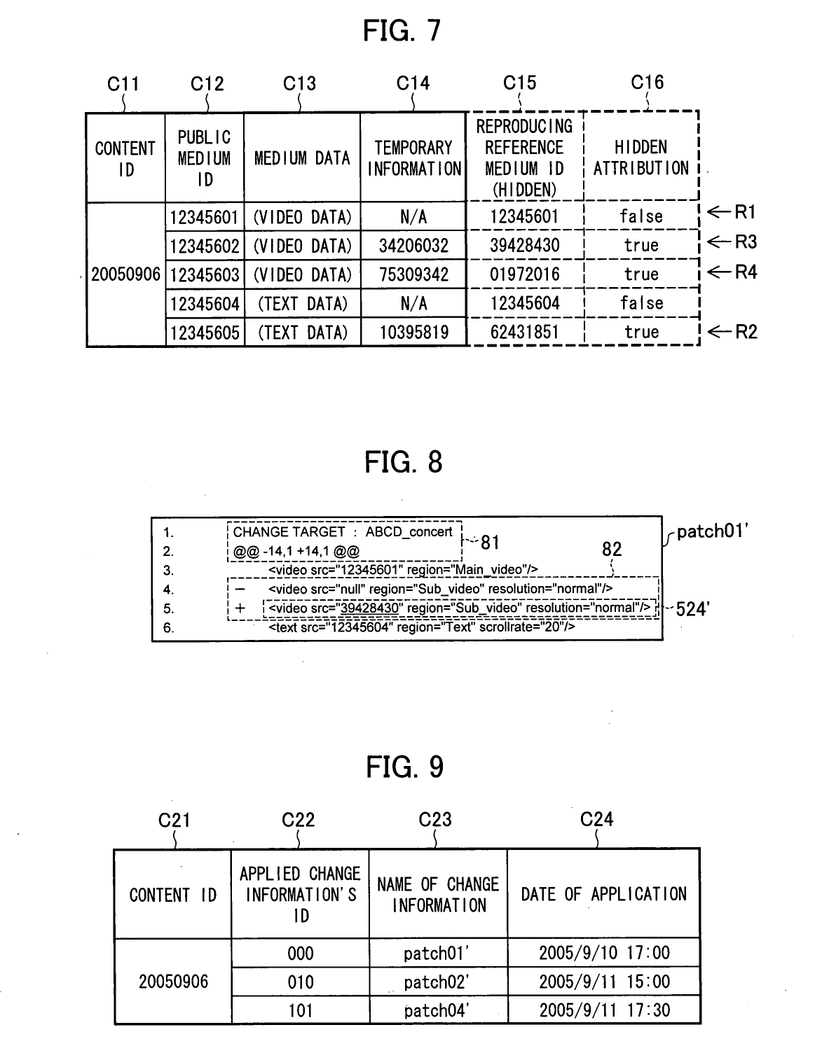

FIG. 7 is a diagram illustrating an example how the content 50 (FIG. 3) is stored in the content storage section 41. In the example shown in FIG. 7, the content is stored in the content storage section 41 in which the table structure is adopted. However, the data structure in the content storage section 41 is not limited to this. The data structure therein may be any structure as long as a correlation between one content and one or more medium objects and a correlation among the various information in each of the medium objects are clear in the data structure.

Now, see column C11 in FIG. 7. The content ID is stored therein. The content ID “20050906” of the content 50 shown in FIG. 3 is stored in the case of FIG. 7.

See column C12, which stores the initial medium IDs that are respectively included in the meta information of the medium objects when the content 50 is acquired. Specifically, the column C12 stores the initial medium IDs of the medium objects 53 to 57 of the content 50 such that the medium IDs thereof are correlated with the content ID that the content 50 has and that is stored in C11.

These information are recorded onto each of the columns C11 and C12 by recording, thereonto as it is, the result of the analysis carried out by the content analyzing section 26. The IDs stored in the column C12 are IDs given to the medium objects of the content for the purpose of managing the medium objects, and are known to the user. Therefore, each of the IDs stored in the column C12 is hereinafter referred to as “public medium ID (first medium ID)”. The use of such public medium IDs allows the content managing section 21 to uniquely identify the medium objects. This makes it possible to carry out management upon the recording and the reproducing of the medium objects.

Note that, in the present embodiment, the public medium IDs are used to identify the medium objects and are different from reproducing reference medium IDs (second medium IDs), respectively. The reproducing reference medium IDs respectively indicate where in the content storage section 41 the medium objects are stored, i.e., storage regions in which the medium objects are stored. For reproduction of a medium object, the content managing section 21 identifies the medium object to be reproduced, with the use of the public medium ID given to the medium object. Then, in reference to the reproducing reference medium ID given thereto, the content managing section 21 specifies a storage region in which the content is stored, and reads out the content from the content storage section 41.

Column C13 stores the medium data respectively contained in the medium objects 53 to 57 of the content 50. However, in cases where the medium data to be reproduced are not acquired in the form of data files but are acquired in a real-time streaming manner, the column C13 may merely store reference information required for the reproducing of the data.

Column C14 stores the temporary information generated by the temporary information generating section 21a, as they are. As described above, the temporary information are given only to the medium objects each including the storage procedure information designating the hidden storage method. Therefore, with regard to the medium objects each including the storage procedure information designating the normal storage method, information “N/A”, which indicates that there is no temporary information, is stored in the column C14.

Note that each temporary information shown in FIG. 7 is constituted by an 8-digit number; however, this is a mere example, so that the present invention is not limited to this. The temporary information may be constituted by any digit number as long as it is possible to secure such a length that makes it sufficiently difficult to conceive the temporary information.

Column 15 stores the reproducing reference medium IDs (hidden), which indicate where in the content storage section 41 the medium objects are stored, respectively. The reproducing reference medium IDs are calculated from (i) the medium IDs stored in the column C12 and (ii) the temporary information stored in the column C14, respectively. When reading out a medium object from the content reproducing section 41 so as to reproduce the medium object, the content managing section 21 makes reference to the reproducing reference medium ID of the medium object.

Here, in the present embodiment, the reproducing reference medium IDs of the medium objects in which the hidden storage method is designated are not stored in the content storage section 41 such that the user is prevented from maliciously extracting the reproducing reference medium IDs thereof. This prevents illegal use of the medium objects. The reproducing reference medium ID of each of the medium objects in which the hidden storage method is designated is calculated by the reproducing reference medium ID calculating section 21b in accordance with a private function, when the medium object is recorded onto the content storage section 41 and every time the medium object is reproduced. Meanwhile, in the case of the medium objects in which the normal storage method is designated, the public medium IDs corresponding to the medium objects and stored in the column C12 may be stored as the reproducing reference medium IDs thereof, respectively. Thus, the content managing section 21 makes reference to each of the public medium IDs obtained upon the acquisition of the content 50, so as to read out corresponding medium data to be reproduced.

A conceivable way in which the reproducing reference medium ID calculating section 21b calculates each of the reproducing reference medium IDs of the medium objects in which the hidden storage method is designated is to carry out calculation in accordance with the private function with the use of each of the public medium IDs stored in the column C12 and each of the temporary information stored in the column C14. More specifically, for example, the reproducing reference medium ID can be calculated as follows. That is, the 8-digit number of the medium ID stored in the column C12 is combined with the 8-digit number of the temporary information such that the 8-digit number of the temporary information comes right to the 8-digit number of the medium ID, thus obtaining a 16-digit number. Then, the reproducing reference medium ID calculating section 21b inputs the 16-digit number to a private one-way hash function. An output result from the one-way hash function is used for the reproducing reference medium ID. An example of the one-way hash function is SHA-1 (Secure Hash Algorithm 1), or the like. For ease of explanation, the reproducing reference medium ID stored in the column C15 is expressed by an 8-digit number in FIG. 7; however, the present invention is not limited to this. Instead of extracting a part of the calculation result obtained through SHA-1 as such, the entire result obtained therethrough may be stored in the column C15.

Every time the medium ID (public medium ID) stored in the column C12 is converted into the medium ID (reproducing reference medium ID) to be stored in the column C15, different temporary information is used. Further, the function for use in the conversion is private. This makes it difficult to conceive the reproducing reference medium ID that corresponds to the medium object in which the hidden storage method is designated and that is stored in the column C15. Accordingly, the content stored in the content storage section 41 is less likely to be distributed without permission. Further, the reproducing reference medium ID of the medium object in which the hidden storage method is designated is calculated by the reproducing reference medium ID calculating section 21b, when the medium object is recorded onto the content storage section 41 and every time the medium object is reproduced. This makes it unnecessary to store the reproducing reference medium ID in the content storage section 41, thereby preventing the user from reading out and reproducing the hidden medium object with ease. Accordingly, it is possible to restrain an ineligible user from reproducing such a specific medium object.

Column C16 stores a value of the storage procedure information described in the meta information of each medium object. Specifically, the column C16 stores the value (“true” or “false”) of the content attribution of the hidden attribution. In the present embodiment, the value of the content attribution is “false” by default, and the default value “false” is used when the value of the content attribution is not particularly described. The content managing section 21 makes reference to the value of the storage procedure information in the column C16 so as to judge whether the hidden storage method or the normal storage method is designated for the medium object. Note that the storage procedure information is never used after the content managing section 21 makes reference thereto so as to record the medium object, so that the storage procedure information may not be so stored in the content storage section 41 as to be correlated with the medium object. It is possible to judge whether the medium object is stored in accordance with the hidden storage method or the normal storage method, by judging whether or not the temporary information is stored in the column C14.

(Details about the Change Information)

The following explains change information acquired by the change information acquiring section 23 after the user designates a change pattern. The description herein exemplifies a case where the user designates, among the change patterns in the change pattern information 512 shown in FIG. 4, the change pattern described in the fifth line of the content information 51, i.e., the change pattern correlated with the change information ID “000”.

FIG. 8 is a diagram illustrating a concrete example in which the change information acquiring section 23 acquires the change information (hereinafter, referred to as patch 01′) in accordance with the change information ID “000” in response to the designation of the change pattern described in the fifth line of the content information 51 shown in FIG. 4.

The patch 01′ includes change target information 81 and change procedure information 82. The change target information 81 specifies either a target content to be changed or a part of the target content. The change procedure information 82 designates how the data specified by the change target information 81 is to be changed.

In the example shown in FIG. 8, the change target information 81 specifies, as a change target, the fourteenth line of the data (the presentation object 52 shown in FIG. 5) whose filename is “ABCD_concert”.

The change procedure information 82 indicates such a change procedure that the original data (reproducing setting information 524) described in the fourteenth line of the presentation object 52 is to be replaced with the customized data (reproducing setting information 524′) described in the fifth line of the patch 01′.

The change information combining section 24 carries out a process of combining the patch 01′ with the content 50 (specifically speaking, the change information combining section 24 carries out a customizing process of replacing the reproducing setting information 524 with the reproducing setting information 524′), with the result that the original content 50 is changed to a customized content 50′, which is to be reproduced in the digital television 100. That is, at the moment of the acquisition of the content 50 (FIG. 5), no medium object was supposed to be reproduced (“null”) on the sub display region (“Sub_video”) as indicated by the reproducing setting information 524. However, after the customizing process, the medium object whose reproducing reference medium ID is “39428430” is to be reproduced on the sub display region as indicated by the reproducing setting information 524′.

The medium object whose reproducing reference medium ID is “39428430” is the medium object that has been designated as the correlated medium and that has the public medium ID “12345602”, namely, is the medium object 54 (FIG. 3) that has been given the temporary information “34206032” and that therefore has been recorded in accordance with the hidden storage method.

As described above, the acquisition of the change information (patch 01′) shown in FIG. 8 makes it possible to display the medium data 542 (FIG. 3) of the medium object 54 on the sub display region, which medium data 542 was not supposed to be displayed on the sub display region because no reference information was designated.

Such change information, transmitted from the content providing device 200 to the digital television 100 for the sake of changing, i.e., customizing the target medium object of the content, is described by the description language, and has therefore a small amount of data. This makes it possible to restrain (i) loads on communication lines or (ii) communication cost, while providing a customized content that meets the user's diverse needs.

Further, the reproducing reference medium ID of the target medium object is hidden using the temporary information, with the result that the user is prevented from maliciously reproducing the target medium object. The medium object thus hidden is allowed to be reproduced only when the change information corresponding to the medium object is acquired. This makes it easy to manage license of the medium object, i.e., makes it possible to prevent illegal use of the medium object and illegal copy thereof.

Note that details about the structure of the change information generating device for generating the change information in accordance with the request from the digital television 100 will be described later.

(Change History Storage Section)

FIG. 9 is a diagram illustrating an example of change history information recorded onto the change history storage section 42 (FIG. 1). The change history information is information indicating what change information has been applied to (combined with) what content. Therefore, the change history information stores a change history for every content, so that the change history is recorded therein every time change information is combined with the content.

See column C21 storing the content ID of a content to which change information has been combined. In the example shown in FIG. 9, the content ID of the content 50 is stored therein.

Column C22 and column C23 store information concerning change information having been applied to the content 50. In the example of FIG. 9, the column C22 stores the respective change information IDs of change information having been applied to the content 50, and the column C23 may store the respective filenames of the change information.

Further, the date of application when the change information has been combined with the content 50 may be stored as shown in column C24. This makes it possible to recognize a state of the latest content 50′ updated as a result of the application of the change information.

Note that the fields constituting the change history information are not limited to the above. Further, the change history information is indicated by way of the table structure; however, the data structure is not limited to this. The data structure may be any data structure as long as a correlation between one content and one or more change information applied thereto is clear in the data structure.

Further, in cases where change information has been already applied to a content to be reproduced as is the case with the example shown in FIG. 9, it is possible to reproduce the content updated to the latest state as a result of the application of the latest change information. That is, every time the content 50 having the content ID “20050906” is instructed to be reproduced, it is possible to reproduce the content 50′ customized by applying the respective change information (patches 01′, 02′, and 04′) to the content 50.

Alternatively, the content may be reproduced with arbitrary change information applied. For example, the change information, the patch 04′, may be exempted from the application of the series of change information to the content, with the result that the content to which the change information, the patches 01′ and 02′, have been applied is to be reproduced.

Note that there are change information that cannot be applied to one content (or medium object) at the same time. In the case of providing such selective change pattern variations, group identifiers are respectively provided in the change information IDs of the change information, and the change information having the same group identifier are prevented from being applied to the content at the same time. This makes it possible to manage the change information and the change history information.

Explained next are (i) a flow of the process of generating the change pattern list in the digital television 100 and (ii) a flow of the process of acquiring the change information therein. The description herein exemplifies a case where the digital television 100 receives an instruction of reproducing the content 50 shown in FIG. 3 and stored in the content storage section 41 in the manner shown in FIG. 7.

(Change Pattern List Generating Process)

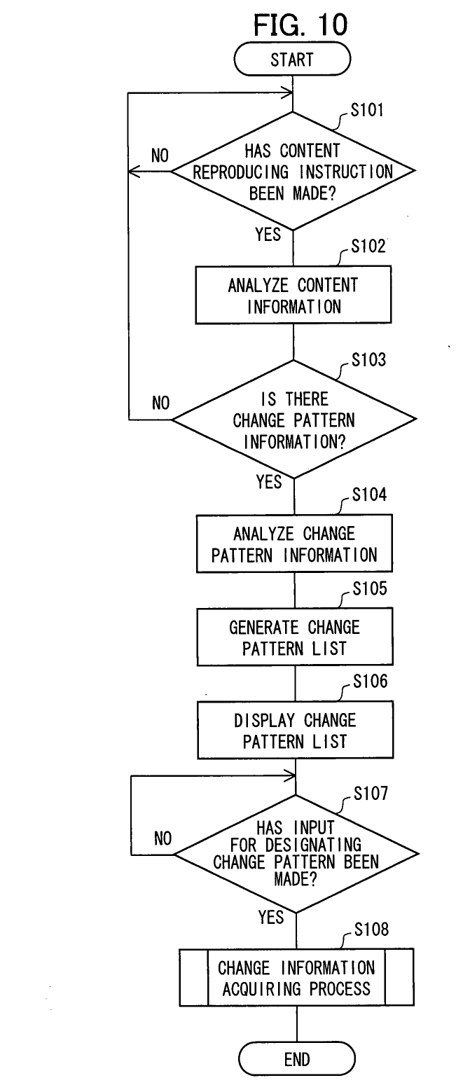

FIG. 10 is a flowchart illustrating the flows of the processes in the digital television 100.

When the operation receiving section 13 receives the content reproducing instruction from the user via the operation section 5 (S101), the content managing section 21 reads out, from the content storage section 41, the content 50 that has been instructed to be reproduced, and the content analyzing section 26 analyzes the content thus read out (S102). In accordance with the result of the analysis carried out by the content analyzing section 26, the change pattern list generating section 22 detects that the content 50 includes the content information 51 and the change pattern information 512 shown in FIG. 4 (YES in S103). Then, the change pattern list generating process is started.

The change pattern list generating section 22 uses the content analyzing section 26 for the purpose of analyzing the change pattern information 512 (S104). Assume that the user has simultaneously inputted (i) the content reproducing instruction and (ii) an instruction of displaying a change pattern list on the sub display region. Therefore, as selection items representing change patterns applicable to the sub display region, the change pattern list generating section 22 generates such a change pattern list that includes the change patterns whose first digit is “0” and which are respectively described in the fifth line and the sixth line of the content information 51 (S105).

The change pattern list output control section 14 sends, to the display section 6, the change pattern list generated in S105 (S106). Then, the change pattern list is displayed on the display section 6. Examples of how the change pattern list is displayed will be described later.

When the user inputs such an instruction as to designate any one of the change patterns from the change pattern list thus displayed (YES in S107), the change information acquiring section 23 carries out the process of acquiring change information corresponding to the designated change pattern (S108).

According to the above process, the change pattern list generating section 22 generates, in accordance with the change pattern information 512 of the content information 51, the change pattern list showing the change patterns applicable to the content to be reproduced. From the change patterns shown in the change pattern list, the change information acquiring section 23 specifies the change pattern designated by the user, and acquires the corresponding change information.

In this way, the content 50 is customized as the user desires. Further, the change information is constructed by the description language such as XML, and therefore has a small amount of information as compared with a case where various types of video data and/or audio data are supplied so as to replace corresponding data in the content 50 for the purpose of customizing. That is, the information amount of the data required for the customizing of the content is small, so that communication cost is restrained but it is possible to distribute a content that meets the user's diverse needs.

(Content Storage Process)

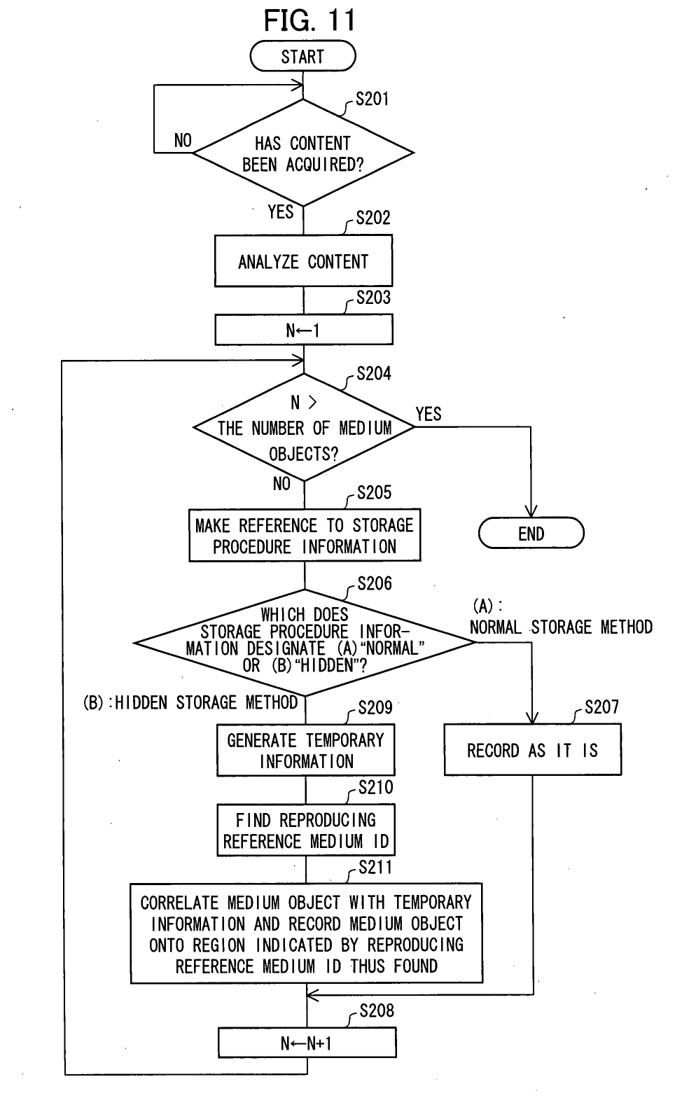

FIG. 11 is a flowchart illustrating a flow of the content storage process carried out by the content managing section 21 so as to record an acquired content. The description herein exemplifies a case where the content 50 shown in FIG. 3 has been acquired.

When the acquired content 50 is supplied to the content processing section 20 via the content input control section 11 (YES in S201), the content analyzing section 26 carries out lexical analysis with respect to the content 50 (S202). This process of analyzing the content results in recognition of the components of the content 50 shown in FIG. 3, i.e., the content information 51, the presentation object 52, and the medium objects 53 to 57. Also recognized on this occasion is the number (five in this case) of the medium objects contained in the content 50.

Carried out next is a process of recording the medium objects 53 to 57 onto the content storage section 41 such that the medium objects 53 to 57 are correlated with the content 50. Specifically, the content managing section 21 firstly initializes a variable N at 1 (S203), and then judges whether or not the variable N is larger than the number (five in this case) of the medium objects of the content 50 (S204).

When judging that N≦5 (NO in S204), the content managing section 21 makes reference to the storage procedure information contained in the meta information of the N-th medium object (S205), and then judges whether the normal storage method or the hidden storage method is designated in the storage procedure information (S206).

Here, consider a case where the N-th medium object is the medium object 53, for example. In this case, in accordance with the storage procedure information of the medium object 53, the content managing section 21 judges that the medium object 53 is to be stored in accordance with the normal storage method (S206-A). In the following case, it is judged that the normal storage method is designated, for example: (i) a case where the meta information include no hidden attribution; (ii) a case where the content attribution in the hidden attribution indicates “false”; or the like.

In this case, the content managing section 21 never converts the public medium ID originally given to the medium object 53, but correlates it with the medium object 53 as the reproducing reference medium ID, and records the medium object 53 onto a region (record R1 shown in FIG. 7) of the content storage section 41 as indicated by the reproducing reference medium ID (S207).

When the recording of the medium object has been finished, one is added to the variable N (S208). Then, the sequence goes back to the judgment in S204.

Meanwhile, consider a case where, e.g., the N-th medium object is the medium object 57 in S206. In this case, in accordance with the storage procedure information of the medium object 57, the content managing section 21 judges that the medium object 57 is to be stored in accordance with the hidden storage method (S206-B). In the following case, it is judged that the hidden storage method is designated, for example: a case where the content attribution in the hidden attribution indicates “true”; or the like.

In this case, after the judgment, the temporary information generating section 21a generates temporary information, which is a random number (S209). Here, the temporary information thus generated is “10395819”. The reproducing reference medium ID calculating section 21b inputs the public medium ID (“12345605”) and the temporary information into the one-way hash function, obtains information as a result of the inputting, and outputs the obtained information as a new medium ID, i.e., a reproducing reference medium ID (“62431851”) (S210). Next, the content managing section 21 correlates the medium object 57 with the temporary information, and records the medium object 57 onto a storage region (record R2 shown in FIG. 7) in the content storage section 41 as indicated by the reproducing reference medium ID found in S210 (S211).

When the recording of the medium object has been finished, one is added to the variable N (S208). Then, the sequence goes back to the judgment in S204. In cases where it is judged that N>5 (YES in S204), the content storage process is terminated.

Meanwhile, consider a case where the content 50 is acquired in the offline manner from a DVD or a removable hard disk via the external interface section 4 and contains medium data that cannot be changed (whose public medium ID cannot be inputted into the hash function so as to be used as the reproducing reference medium ID). In this case, such medium data does not need to be recorded onto the content storage section 41, and medium objects are kept in the DVD or the removable hard disk. It is possible to make reference to a target medium object of the medium objects, as long as storage procedure information of the target medium object designates the normal storage method. This reduces the amount of data stored in the content storage section 41.

(Content Reproducing Process)

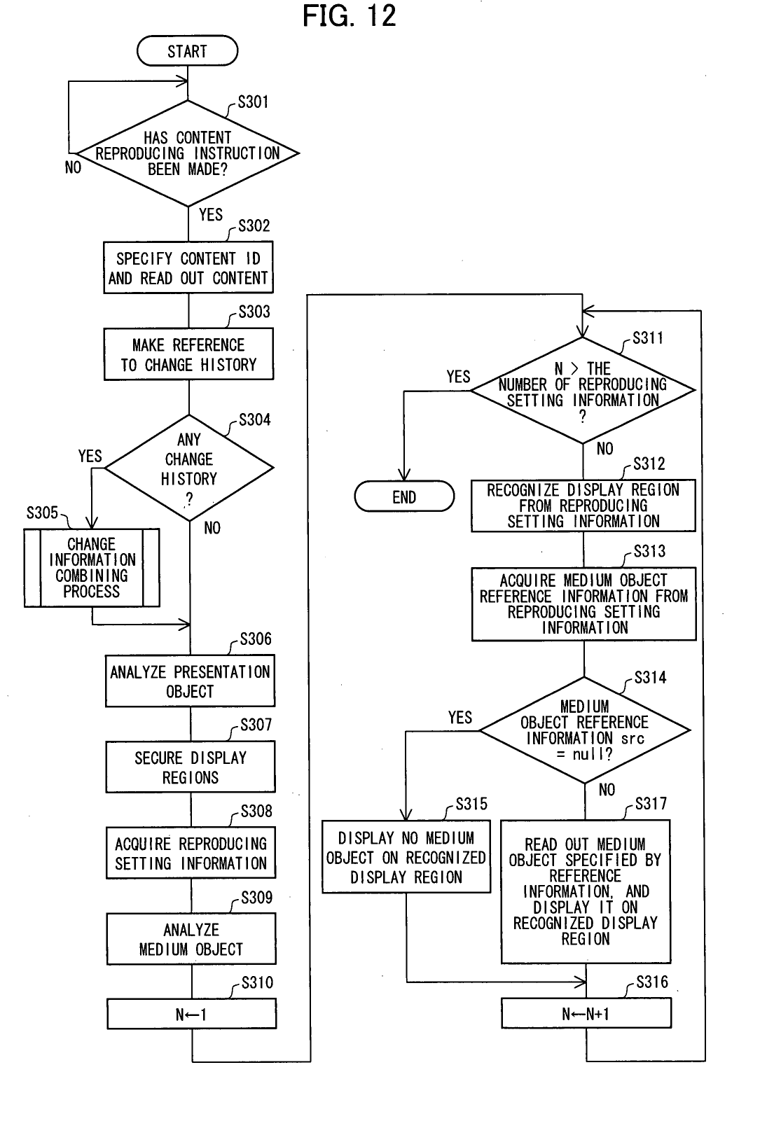

FIG. 12 is a flowchart illustrating a flow of the content reproducing process in which the content reproducing section 25 reproduces a content. The description herein exemplifies a case where the content 50 (see FIG. 3), which is an original one, is reproduced.

When the operation receiving section 13 receives, from the user via the operation section 5, an instruction of reproducing the content 50 (YES in S301), the content managing section 21 reads out the content 50 from the content storage section 41 in accordance with the content ID (“20050906”) of the content 50 thus designated (S302).

Here, as described above, the content managing section 21 may make reference to the change history storage section 42 in accordance with the content ID (S303). In cases where the content managing section 21 judges that there is a history that change information has been already applied to the content (YES in S304), the content managing section 21 send, to the change information combining section 24, such an instruction as to carry out the change information combining process in which the change information having been applied to the content 50 before is combined with the content 50 (S305).

In cases where it is judged that there is stored no history as to change information having been applied thereto, the sequence goes to the process of reproducing the original content 50 instructed to be reproduced.

Next, the content analyzing section 26 analyzes the presentation object 52 contained in the content 50 (S306). The result of this content analyzing process is sent to the content reproducing section 25 via the content managing section 21.

This allows the content reproducing section 25 to obtain the layout information 522 (FIG. 5) of the presentation object shown in FIG. 3. In accordance with the layout information 522 shown in the example of FIG. 5, the content reproducing section 25 secures, e.g., the three display regions on the screen of the display section 6 (S307): (i) the main display region serving as the first display region (coordinate (x, y)=(0,0), width of 800 pixels (the unit therefor is not limited to this), and height of 450 pixels); (ii) the sub display region serving as the second display region (coordinate (x, y)=(800,0), width of 200 pixels, and height of 450 pixels); and (iii) the text display region serving as the third display region (coordinate (x, y)=(0,450), width of 1000 pixels, and height of 100 pixels).

Further, in accordance with the result of the content analyzing process carried out by the content analyzing section 26, the content reproducing section 25 acquires the three reproducing setting information 523 to 525 defining what medium objects are to be displayed on the display regions, respectively (S308). Next, the medium objects 53 to 57 are analyzed (S309).

Thereafter, the content reproducing section 25 reproduces the medium objects in accordance with the reference information (information for specifying the medium objects; the reproducing reference medium IDs in this case) contained in the reproducing setting information 523 to 525. More specifically, the reproducing of the medium objects encompasses (i) a process for rendering of medium data such as video data, image data, text data, and web page; and (ii) a process for reproducing of audio data. Note that a decoder required for the reproducing of the medium objects, and a display device required for display thereof may be provided in an external device connected to the digital television 100.

First, the content reproducing section 25 initializes a variable N at 1 (S310). Next, the content reproducing section 25 judges whether or not the variable N is larger than the number of the reproducing setting information (here, three) contained in the presentation object 52 (S311).

In cases where it is judged that N≦3 (NO in S311), the content reproducing section 25 recognizes the display region designated by the N-th reproducing setting information, and specifies the display region of the display section 6 so as to display the corresponding medium object thereon (S312).

Next, the content reproducing section 25 acquires the reference information contained in the reproducing setting information and indicating the medium object, so as to specify the medium object to be displayed on the specified display region (S313). The reference information is the reproducing reference medium ID correlated with the medium object in this case.

Here, in cases where the reference information thus acquired represents no medium object ID (where scr attribution described in each of the reproducing setting information 523 to 525 indicates “null”; YES in S314), the content reproducing section 25 does not display none of the medium objects on the display region recognized in S312 (S315). Then, one is added to the variable N (S316). Thereafter, the sequence goes back to S311.

Meanwhile, in cases where the acquired reference information represents a medium object ID (NO in S314), the content reproducing section 25 carries out a process of displaying, on the display region recognized in S312, the medium object specified by the reproducing reference medium ID (S317). If the medium object thus specified is an encoded one, the medium object is subjected to a decoding process. Thereafter, one is added to the variable N (S316). Thereafter, the sequence goes back to S311.

In cases where it is judged that N>3 (YES in S311), the content reproducing section 25 terminates the content reproducing process carried out with respect to the content 50.

According to the above process, it is possible to control whether or not each of the medium objects is going to be reproduced, by using each reference information concerning the reproducing setting information 523 to 525 and contained in the presentation object 52. Even when no medium object is reproduced, the display regions are secured. This allows the user to know in advance a display region on which an available customized content is to be displayed. Such information concerning the display region helps the user when the user makes a request of reproducing the customized content.

(Change Information Acquiring Process)

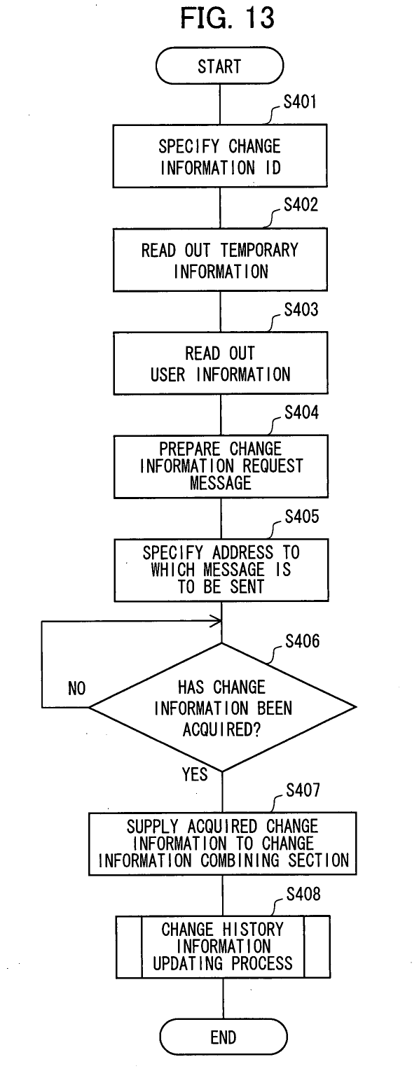

The following explains the details about the change information acquiring process shown in S108 of FIG. 10 and carried out so as to acquire the change information. FIG. 13 is a flowchart illustrating a flow of processes in the change information acquiring process carried out by the change information acquiring section 23. The description herein assumes that the change information is managed by the content providing device 200 serving as the change information generating device, and that the digital television 100 makes a request to the content providing device 200 for change information via the communication network and acquires the target change information from the content providing device 200 via the communication network.

Further, the following description assumes that the user carries out inputting so as to select a change pattern from the change pattern list presented to him/her in accordance with the change pattern information 512 of the content information 51 (FIG. 4) of the content 50.

In S107 shown in FIG. 10, the operation receiving section 13 receives the input from the user via the operation section 5. In cases where the input is made to specify a change pattern, the change information acquiring section 23 starts the change pattern acquiring process.

Here, in cases where it is found, as a result of making reference to the change history storage section 42 before the start of the change information acquiring process, that the change information corresponding to the specified change pattern has been already acquired, the process may be terminated without preparing any change information request message.

The change information acquiring section 23 specifies (i) the content ID of a content currently being reproduced, (ii) the change information ID correlated with the change pattern designated by the user, and (iii) the correlated medium ID (S401). The content ID, the change information ID, and the correlated medium ID are to be contained in the change information request message to be sent to the content providing device 200.

Next, the change information acquiring section 23 extracts the information of the specified content ID from the content storage section 41 (FIG. 7). In cases where there is stored temporary information correlated with the correlated medium ID thus specified, the temporary information is read out (C14 in FIG. 7) (S402).

Next, in cases where the content providing device 200 has the user information (e.g., the user ID and the number of points that the user has) required for management of the change information, the user information may be read out from the user information storage section 43 (S403).

The change information acquiring section 23 prepares the change information request message including the information read out in each of the aforementioned steps (the content ID, the change information ID, the temporary information, the user information, and the like) (S404). The change information request message may include change information ID and temporary information each corresponding to change information having been applied before.

Next, the change information acquiring section 23 specifies the change information acquiring source URI 513, and designates it as an address to which the prepared request message is to be sent (S405). The change information request message thus prepared by the change information acquiring section 23 is transmitted to the designated address, i.e., the content providing device 200 via the communication section 3 (FIG. 2).

In the case of acquiring the change information in the online manner, the change information acquiring section 23 stands by until the change information having been requested is acquired from the content providing device 200 (NO in S406). On the other hand, in the case of acquiring the change information in the offline manner, the change information section 23 stands by until change information readout means (not shown) for reading out the change information from a memory card or a two-dimensional bar code finishes reading out the requested change information.

When the change information acquiring section 23 acquires the requested change information from the content providing device 200 via the communication control section 12 (YES in S406), the change information acquiring section 23 sends the acquired change information to the change information combining section 24 (S407) and terminates the sequence.

Here, after acquiring the target change information, the change information acquiring section 23 may further carry out a process of updating the change history information correlated with the content (content 50 in this case) stored in the change history storage section 42 (S408).

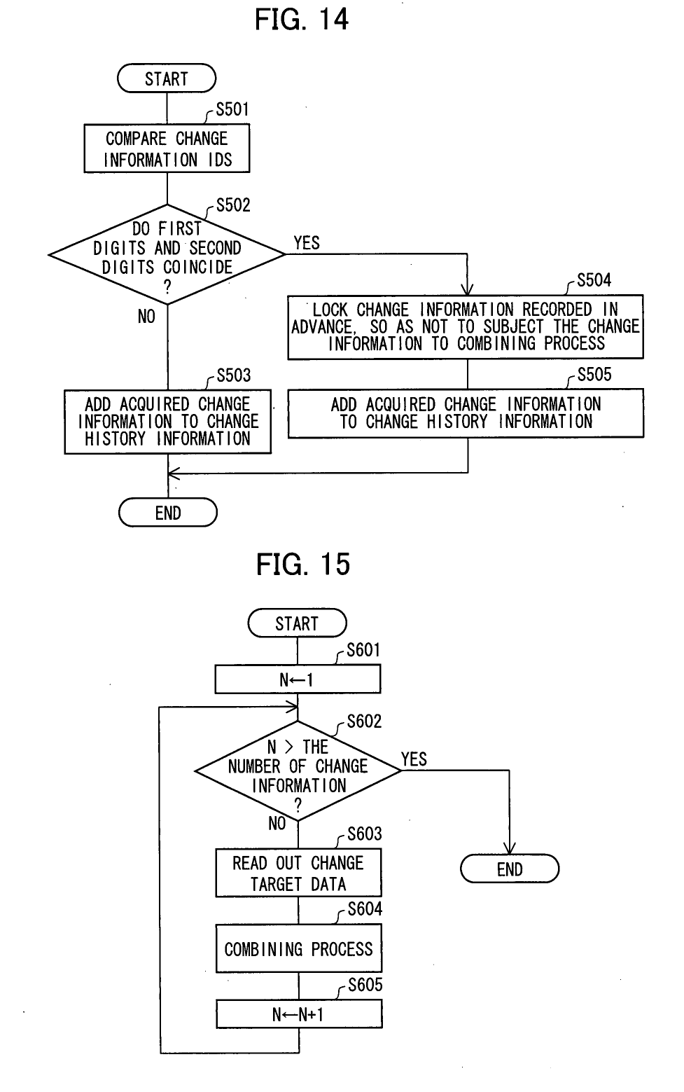

FIG. 14 is a flowchart illustrating a flow of such a change history information updating process carried out by the change information acquiring section 23 after acquiring the target change information, in the above example.

When the change information acquiring section 23 acquires the target change information, the change information acquiring section 23 compares the change information ID of the acquired change information with each of the change information IDs concerning the content 50 and stored in the change information history storage section 42 (S501).

When judging that the change history information does not contain a change information ID whose first and second digits respectively coincide with those of the change information ID of the acquired change information (NO in S502), it is assumed that there is no other change information that specifies the same display region and that cannot be applied at the same time. Therefore, the change information ID of the acquired change information is newly added to the change history storage section 42, and the sequence is terminated (S503).

On the other hand, when judging that the change history information contains a change information ID whose first and second digits respectively coincide with those of the acquired change information (YES in S502), the change information whose first and second digits respectively coinciding with those of the change information recorded in the change history information is locked so as not to be subjected to the combining process carried out by the change information combining section 24 (S504). Then, the change information ID of the acquired change information is newly added to the change history storage section 42, and the sequence is terminated (S505).

Such coincidence in the first and second digits between both the change information means that these change information belong to the same group and are supposed to be displayed on the same display region, so that these change information cannot be simultaneously applied to one content (or medium object). They are distinguished from each other only by the levels of change, which levels are respectively indicated by the third digits thereof.

For application of the newly acquired change information, the change information having been recorded before and belonging to the same group as the newly acquired change information is locked to be prevented from being combined with the content. This makes it possible to carry out control for excluding change information that cannot be used for change of the content at the same time with the other change information, and to secure continuity in change states in cases where the change requests are made step by step or sequentially.

In cases where there is change information belonging to the same group as the newly acquired change information, the change information having been recorded before may be overwritten by the newly acquired change information. Also in this case, the control for excluding change information can be carried out.

Further, in the above example, the change information having been recorded before the newly acquired change information is locked so as not to be subjected to the combining process; however, the present invention is not limited to this. For example, the third digits of them may be compared with each other, and the newest change information of the series of change information (i.e., change information whose level is ahead of those of the other change information) may be combined and the other change information are locked so as not to be subjected to the combining process. In this case, it is possible to carry out the excluding control such that the newest change information of the series of change information is combined with the content irrespective of the order in which the change information are acquired.

(Change Information Combining Process)

The following fully explains the change information combining process shown in S305 of FIG. 12. FIG. 15 is a flowchart illustrating a flow of the change information combining process carried out by the change information combining section 24.

When the operation receiving section 13 receives a content reproducing instruction from the user, the content managing section 21 makes reference to the change history storage section 42 so as to check change history information concerning the designated content. In cases where there is change information correlated with the content, the content managing section 21 instructs the change information combining section 24 to start the process (change information combining process) of applying the change information to the content.

The following explains, as an example, a case where the user instructs reproducing of the content 50 whose content ID is “20050906”, and where the change history information shown in FIG. 9 is stored in the change history storage section 42.

First, the change information combining section 24 initializes a variable N at 1 (S601). Then, the change information combining section 24 judges whether or not the variable N is larger than the number of change information (three in the example shown in FIG. 9) correlated with and applicable to the content 50 (S602).

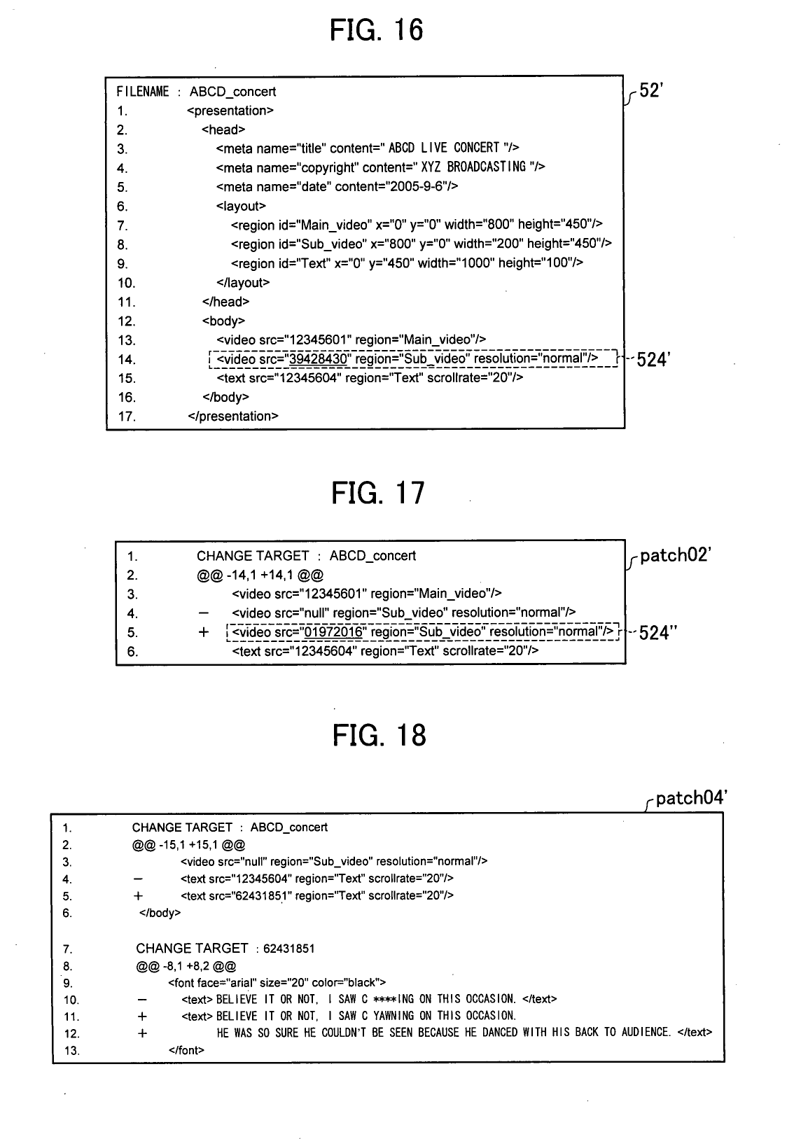

Here, in cases where the change information combining section 24 judges that N<3 (NO in S602), the change information combining section 24 reads out, from the content storage section 41, change target data, which is indicated by the N-th change information (patch 01′, 02′, or 04′ in this case) and to which the change information is to be applied (S603). Next, the change target data read out in S603 is combined with the N-th change information (S604). FIG. 16 is a diagram illustrating a presentation object 52′ obtained by combining (i) the change information (patch 01′) shown in FIG. 8 with (ii) the change target data, i.e., the presentation object 52 shown in FIG. 5. The reproducing setting information 524′ shown in FIG. 8 replaces the fourteenth line of the presentation object 52. As a result of such a change (see an underlined part in FIG. 8 for the changed part), the medium object whose reproducing reference medium ID is “39428430” (record R3 in FIG. 7) is to be displayed on the sub display region. When the above combining process is over, one is added to the variable N (S605). Then, the sequence goes back to S602.

FIG. 17 is a diagram illustrating the change information (patch 02′) to be combined with the presentation object 52′ shown in FIG. 16 and serving as the change target data. As shown in FIG. 17, the change information has reproducing setting information 524″ defining that the video data whose reproducing reference medium ID is “01972016” (record R4 in FIG. 7) is supposed to be displayed on the sub display region. Therefore, when reproducing the content to which the change information (patch 02′) has been applied, the video data indicated in the record R4 shown in FIG. 7 is displayed on the sub display region instead of the video data shown in the record R3.

In cases where the change information combining section 24 judges in S602 that N>3 (YES in S602), the change information combining process is terminated because all the change information have been combined with the content. The content thus combined with the change information is analyzed by the content analyzing section 26 as shown in FIG. 12, and is reproduced in accordance with the description obtained as a result of the combining.

As described above, change information required in customizing a content is acquired according to a user's desire as required, and is managed (PULL type). That is, the change information can be acquired independently from the reception of the content (PUSH type), so that a used storage region and acquisition cost for the change information can be smaller. Note that the manner of acquiring the change information is not limited to the manner in which the change information is acquired via the communication network. The change information may be acquired in the offline manner. Also in this case, the content can be changed.

Note that the change information is not limited to information that defines how the presentation object 52 is customized as is the case with the aforementioned example. That is, the use of the change information makes it possible to change not only a medium object to be made reference, but also a material of the medium object to be made reference. An example of such change information is described in FIG. 18.

The first line to the sixth line of the change information, the patch 04′, are information for changing the presentation object 52 as is the case with the patch 01′, so that explanation therefor is omitted here. Those lines define that text data having the reproducing reference medium ID “12345604” displayed on the text display region is to be replaced with text data having the reproducing reference medium ID “62431851”.

The seventh line to the thirteenth line of the change information, the patch 04′, define that text data in a medium object, which serves as a change target data (medium object 57 shown in FIG. 6), is to be changed. More specifically, these lines define that the eighth line of the medium object 57 shown in FIG. 6 is to be replaced with the eleventh line and the twelfth line of the patch 04′.

When the change information combining section 24 applies such a patch 04′ to a content customized as a result of applying the aforementioned patches 01′ and 02′, text data to be displayed on the text display region is changed from “Believe it or not, I saw C ****ing on this occasion” to “Believe it or not, I saw C yawning on this occasion (the rest is omitted)”.

As such, the change information combining section 24 combines the change information with the content, with the result that not only the video data or the audio data but also the text data can be changed. Further, the change information for use in customizing the text data has a small amount of data. This allows (i) restraint of communication cost for the change information, and (ii) realization of content distribution that meets user's diverse needs.

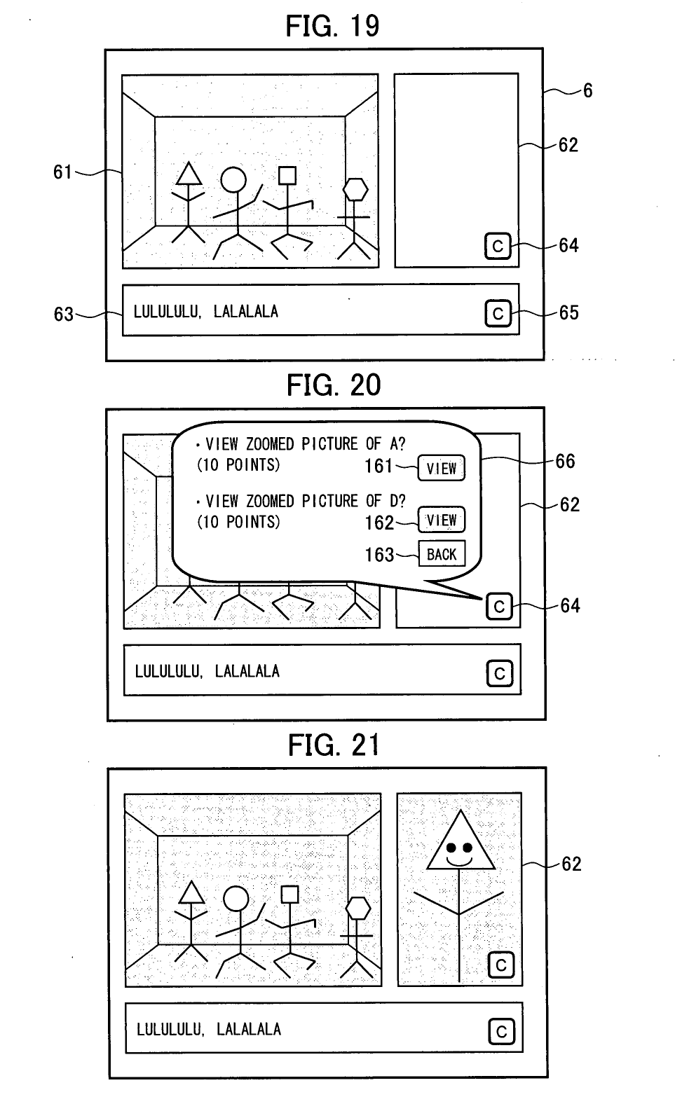

FIG. 19 illustrates an example of the original content 50 displayed on the display section 6 as a result of reproducing the original content 50 in accordance with the aforementioned reproducing setting information 523 to 525 (FIG. 5). A scene displayed as a result of reproducing the content 50 is a scene of a live concert of a certain group.

In accordance with the description of the layout information 522 (FIG. 5), the main display region (region id=“Main_video”) 61, the sub display region (region id=“Sub_video”) 62, and the text display region (region id=“Text”) 63 are secured on the display screen of the display section 6.

In accordance with the description of the reproducing setting information 523, the video data whose reproducing reference medium ID is “12345601” is displayed on the main display region 61. In accordance with the description of the reproducing setting information 524, no medium object is displayed on the sub display region 62. In accordance with the description of the reproducing setting information 525, the text data whose reproducing reference medium ID is “12345604” is scroll-displayed on the text display region 63.

Here, consider a case where the change pattern information 512 (FIG. 4) is contained in the content information 51 of the content 50 to be reproduced. The change pattern information 512 defines a display region to which a change pattern is to be applied. In the example shown in FIG. 4, the change pattern information 512 describes “Sub_video” and “Text”, so that there are change information respectively applicable to the sub display region 62 and the text display region 63.

In order to make the user recognize that there are the change information applicable to these display regions, icons 64 and 65 may be displayed on their corresponding display regions respectively, as shown in FIG. 19. Specifically, in accordance with a result of analysis carried out by the content analyzing section 26, the content reproducing section 25 detects that the change pattern information 512 contains information indicating the sub display region 62 and the text display region 63, and carries out a process of displaying the icons 64 and 65 on their corresponding display regions respectively. When each of the icons 64 and 65 is clicked, the aforementioned change pattern list display process is started.

FIG. 20 illustrates an example of a change pattern list displayed when the user selects the icon 64. Details about the change pattern list displaying process is described above with reference to FIG. 10, so that the explanation therefor will not be repeated.

In response to the selection of the icon 64, the change pattern list generating section 22 generates the change pattern list, i.e., a list of change patterns applicable to the sub display region 62. The list thus generated is displayed, as described in the explanation made with reference to FIG. 10. In the example shown in FIG. 20, the change pattern list is displayed in the form of a dialog balloon 66; however, a way of displaying the change pattern list is not limited to this.

The change patterns of the change pattern information 512 (FIG. 4) have info attributions defining determination button texts, respectively, so that the determination button texts are respectively displayed on determination buttons 161 and 162 displayed on the screen of the display section 6. When the user selects a determination button, corresponding change information is acquired in accordance with the change information ID correlated with the determination button and given to the change information. Further, a cancel button 163 may be displayed as an operation button for allowing the user to select canceling of the change. This allows the user to make such selection that a change applicable to the content (medium object) is not applied thereto intentionally.

FIG. 21 is a diagram illustrating an example of the displayed content customized as a result of the user's selection of the determination button 161.

When the determination button 161 is clicked, the change information (patch 01′) whose change information ID is “000” is acquired and the medium object 54 stored in the hidden manner is displayed on the sub display region 62 in accordance with the change information thus acquired.

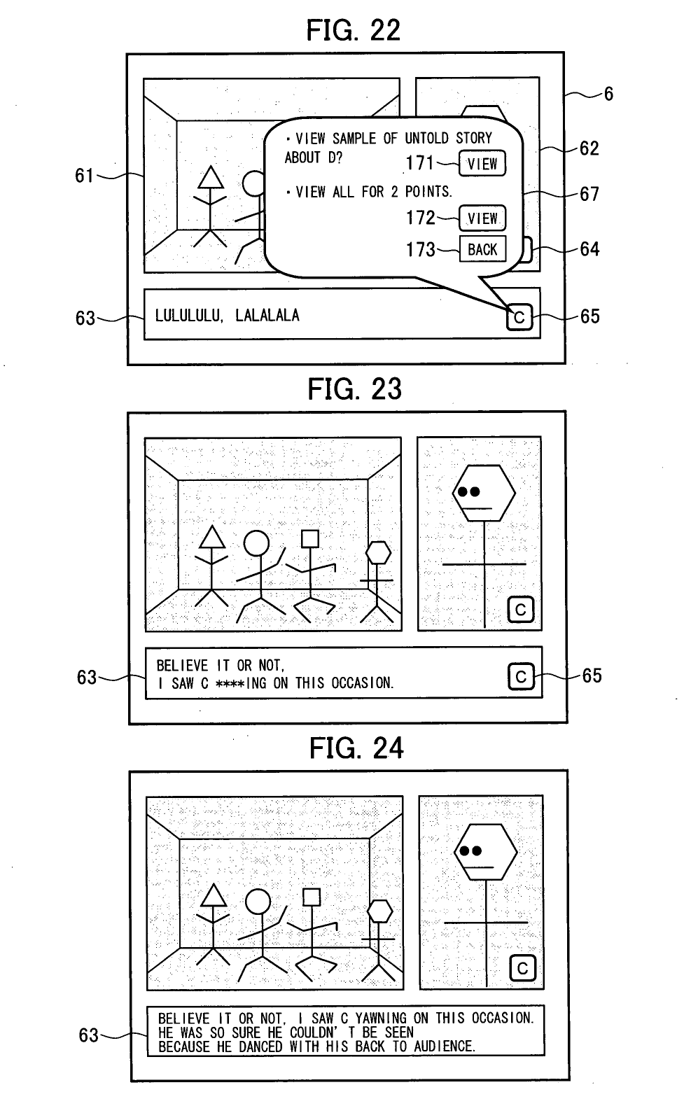

FIG. 22 is a diagram illustrating an example of a change pattern list displayed as a result of selecting the icon 65 after the display of the content customized as a result of the user's selection of the determination button 162.

When the icon 65 is selected, the change pattern list generating section 22 causes display of a dialog balloon 67, which serves as a change pattern list showing change patterns applicable to the text display region 63. On this occasion, determination buttons 171 and 172 and cancel button 173 may be displayed.

FIG. 23 is a diagram illustrating an example of the content customized as a result of the user's selection of the determination button 171. The change information combining section 24 combines the change information (patch 02′) whose change information ID is “100,”, with the content. In accordance with the content thus combined with the change information, the content reproducing section 25 displays, on the text display region 63, the medium object 57 containing the incomplete medium data.

FIG. 24 is a diagram illustrating an example of the content customized as a result of the user's selection of the determination button 172. The user may or may not select the determination button 172 if he/she views the incomplete data and would like to view the complete data. When this change pattern is designated, change information patch 02′+04′ is applied. This change information defines that the incomplete medium object 57 stored in the content storage section 41 in accordance with the hidden storage method is going to be replaced and information that does not exist in the incomplete medium object 57 is going to be added.

As such, by applying the acquired change information, the content can be customized in detail.

### Embodiment 2

In the foregoing embodiment, the content providing device 200 includes the change information generating device for supplying the change information, supplies the content to the digital television 100 via the broadcasting wave (PUSH type), and supplies the change information thereto via the communication network (PULL type). However, the content distribution system of the present invention is not limited to such a system. It is possible to construct a content distribution system in which the change information generating device is provided separately from the content providing device 200.

(Content Distribution System)

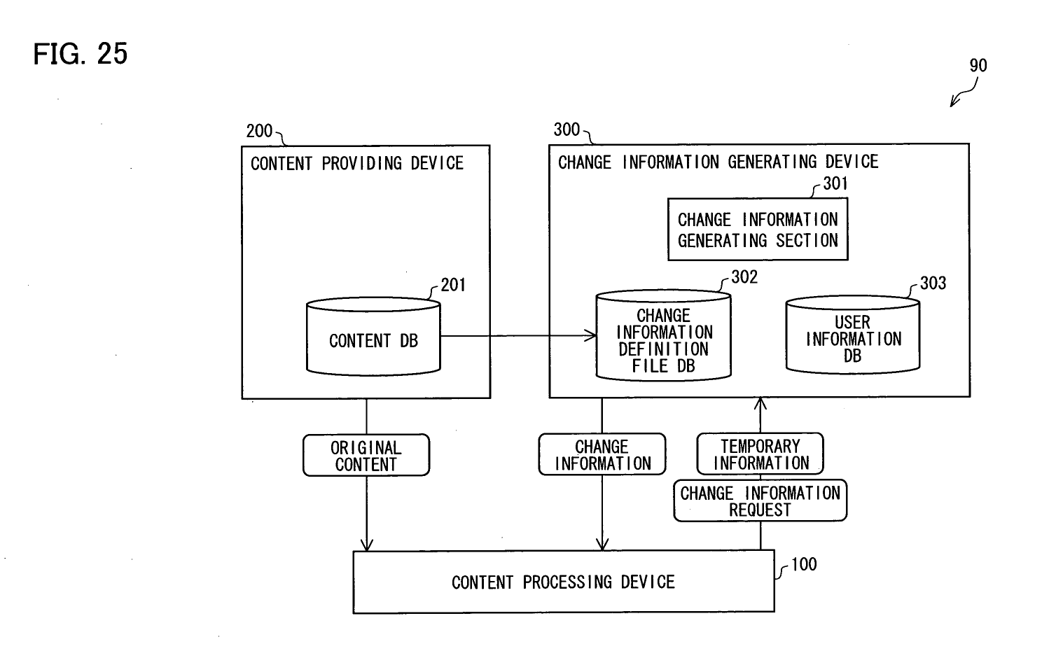

FIG. 25 is a diagram schematically illustrating a structure of such a content distribution system 90 according to the present embodiment.

The content providing device 200 provides a content via a broadcasting wave, and includes a content DB (database) 201.

The change information generating device 300 supplies requested change information to the digital television 100 via a communication network in response to a change information request message received from the digital television 100.

(Structure of the Change Information Providing Device 300)

The change information generating device 300 includes: a change information generating section (ID converting means/change information generating means) 301; a change information definition file DB 302; and a user information DB 303. The change information generating section 301 generates change information accommodating to a client (digital television 100). The change information definition file DB 302 stores definition files for the change information. Each of the definition files is used for generation of the change information. The user information DB 303 stores user information concerning a user of the digital television 100 who uses a service of the change information generating device 300.

In response to a request (change information request message) from the digital television 100, the change information generating section 301 reads out, from the change information definition file DB 302, a change information definition file defining the requested change information, and uses the readout change information definition file so as to generate the change information to be supplied to the digital television 100.

The change information definition file DB (definition file database) 302 stores the change information definition files such that the change information definition files are correlated with contents stored in the content DB 201 of the content providing device 200. A plurality of change information may correspond to one content, so that a plurality of change information definition files may be correlated with one content. The change information definition files are given change information IDs so as to be managed, respectively. Further, the change information definition file DB 302 stores the change information IDs such that each of the change information IDs is correlated with (i) a change information definition file and (ii) right information required for change of a content. The right information is information indicative of the number of points that the user consumes for a customized content.

The user information DB 303 stores user identification information (user ID) such that the user identification information is correlated with the right information (points) that the user uses to change a content.

When receiving a change information request message from the digital television 100, the change information generating section 301 specifies a change information definition file required for generation of requested change information, and extracts information correlated with the change information definition file and indicating the number of points (e.g., 10 points). Then, the change information generating section 301 carries out a process of subtracting 10 points from the points that the user who has made the request has and that is correlated with the user ID of the user; and the like.

It is possible to construct a content distribution system for providing change information to a user from a content provider or a content creator who owns such a content providing device 200 that includes the change information section 301, the change information definition file DB 302, and the user information DB 303. However, as is the case with the above example, it is also possible that a change information provider who owns the change information generating device 300 and who recognizes specifications of contents makes change information on his/her own. In the latter case, it is possible to construct a new business model in, e.g., a field of broadcasting.

(Change Information Definition File DB)

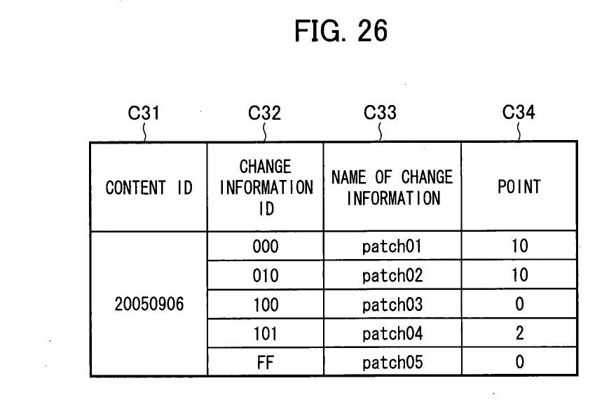

FIG. 26 is a diagram illustrating an example of the change information definition file DB 302 of the change information generating device 300. The example shown in FIG. 26 concerns the change information correlated with the content 50 shown in FIG. 3.

See column C31 storing the content ID. The content ID stored herein is “20050906” as is the case with the foregoing example.

Column C32 stores the change information ID, which is correlated with the change pattern information 512 shown in FIG. 4.

Column C33 stores the filenames of the change information definition files. Each of the change information definition files is a base file, based on which the change information generating section 301 generates change information according to a client (digital television 100 or the like).

Column C34 stores the information indicative of the number of points that the user is to consume for acquisition of each of the change information. The number of points may be determined by the change information provider, and may be described in the change pattern information 512 so as to be presented to the user before he/she carries out a change operation. This allows the user to know in advance how many points are to be consumed for application of each of the change patterns.

In this way, in accordance with the content ID and the change information ID each contained in the change information request message sent from the digital television 100, the change information generating device 300 specifies a change information definition file corresponding to the change information to be supplied. This makes it possible to generate the change information according to the request from the digital television 100.

(Change Information Definition File)

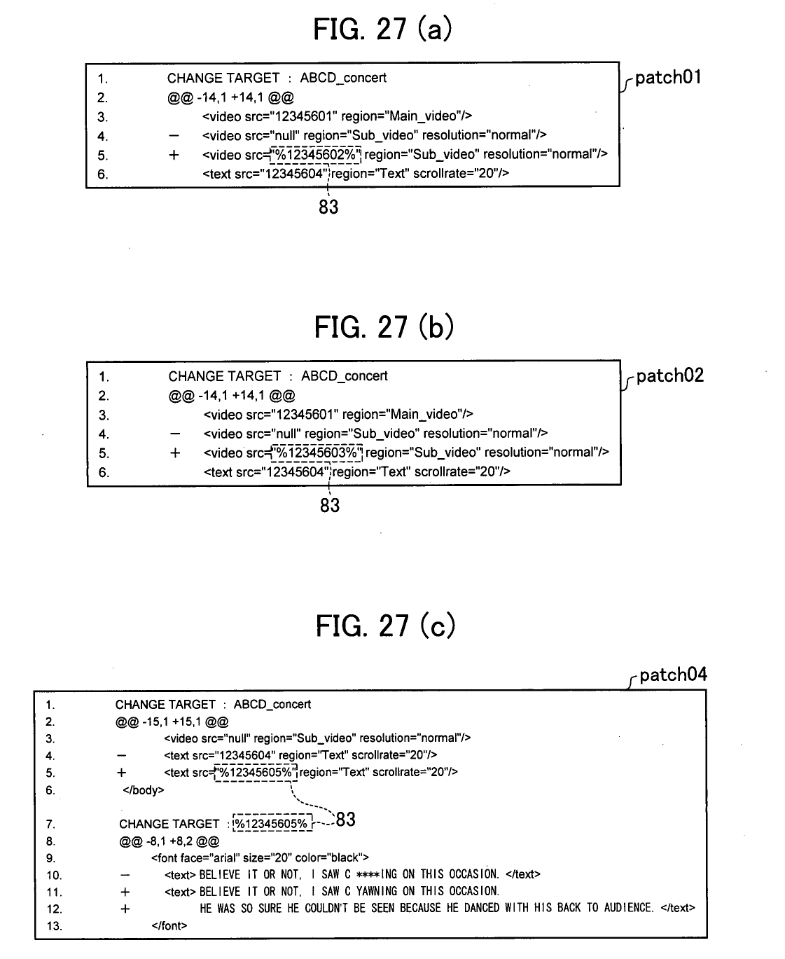

Next, FIG. 27 illustrate examples of the change information definition files.

FIG. 27(a) is a diagram illustrating a change information definition file patch 01, which is a base file for the change information patch 01′ shown in FIG. 8.

FIG. 27(b) is a diagram illustrating a change information definition file patch 02, which is a base file for the change information patch 02′ shown in FIG. 17.

FIG. 27(c) is a diagram illustrating a change information definition file patch 04, which is a base file for the change information patch 04′ shown in FIG. 18.

Each of the change information definition files looks the same as the change information; however, the change information definition file is different from the change information in that the reference information of each medium object is described as provisional reference information 83.

For example, the fifth line of the change information definition file patch 01 shown in FIG. 27(a) describes a letter string “%12345602%”. This portion in the change information definition file patch 01, i.e., the letter string will differ among digital televisions 100 because each of the digital televisions 100 calculates the medium ID in accordance with the temporary information generated by the digital television 100 and uses the calculated medium ID as the reproducing reference medium ID. For this reason, the reference information of the medium object in the change information definition file is handled as the provisional reference information.

Therefore, the change information is obtained by combining the change information definition file with the corresponding temporary information supplied from the digital television 100. More specifically, the change information generating section 301 applies (i) the temporary information attached with the request message sent from the digital television 100, to (ii) the portion describing the provisional reference information “%12345602%” in the change information definition file patch 01. As a result, the reference information “39428430” is calculated, and then the change information is generated and supplied to the digital television 100.

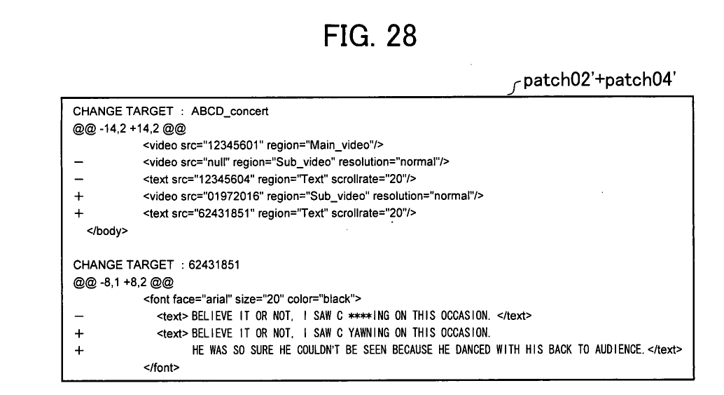

FIG. 28 illustrates the change information patch 02′+patch 04′, which is generated by the change information generating section 301 in accordance with the change information definition files patch 02 and patch 04 respectively shown in FIG. 27(b) and FIG. 27(c).

In the example shown in FIG. 28, the change information generating section 301 checks change targets described in the change information definition files and finds that the change information definition files indicate that changes are supposed to be made with respect to the same change target. In such a case, one change information is generated which indicates both (i) a result of recalculation for the lines to be replaced and (ii) how the content is to be changed. With this, the transmission/reception between the digital television 100 and the change information generating device 300 and the processes are carried out less frequently, with the result that efficiency in acquiring the change information is improved.

Further, as evident from the aforementioned example of the change information, it is possible to describe, in one change information, that (i) the control over the reproduction of the medium data is to be carried out by replacing the reference information and (ii) the material of the content is to be changed by replacing the material of the medium data. With this, the control over the reproduction of the medium data and the changing of the material of the content can be carried out by the same members in the digital television 100 (the content analyzing section 26, the change information combining section 24, and the content reproducing section 25 (FIG. 1)).

Further, the number of letters in the change information shown in FIG. 28 is approximately 520, so that the change information only has an information amount of 1 KB. The number of letters that can be contained in a two-dimensional barcode is approximately 1800. Hence, such information whose size is very small allows realization of customizing of a content. Such a content distribution system of the present invention is applicable to (i) use of a mobile phone and (ii) a system in which the change information is transmitted/received in the offline manner.

(Modified Example)

In the aforementioned embodiments, the accumulation and the management of the change history information are carried out by the client side, the digital television 100; however, the present invention is not limited to this.

For example, the user information DB 303 of the change information generating device 300 can be so arranged as to manage the change history information for each user. This increases (i) processes in the change information generating device 300 and (ii) an amount of data stored in the user information DB 303; however, the digital television 100 does not need to carry out the process of managing the change history information. Thus, when a request is made for readout of temporary information, the readout is carried out only once, with the result that processing efficiency is improved.

Meanwhile, the aforementioned embodiments describe the case where the transmission/reception of the change information request message and the change information is carried out in the online manner; however, the present invention is not limited to this. The transmission/reception thereof is carried out in the offline manner in, e.g., the following two cases.

The first case is a case where the user is allowed to operate the change information generating device 300 directly or indirectly. In this case, the content reproducing section 25 of the digital television 100 has a function of displaying the content ID 511 contained in the content 50, and the change information generating device 300 has (i) an input section (not shown) from which the content ID and the user information can be inputted into the change information generating device 300, and (ii) the change pattern list generating section 22. When the user inputs the content ID and the user ID into the change information generating device 300, the change information generating section 301 of the change information generating device 300 generates the change information in reference to the change information definition file DB 302, and the change information thus generated may be stored in a memory card or be issued as a two-dimensional barcode.

With this, all the processes for recording the change history information onto the change history storage section 42 do not need to be carried out in the digital television 100. However, the temporary information needs to be notified to the change information generating device 300 for the purpose of reproducing the medium object stored in accordance with the hidden storage method, so that the data stored in content storage section 41 needs to be stored in advance in a memory card, or a list of the temporary information needs to be presented to the user such that the user selects and inputs the temporary information.

The second case is a case where the user cannot operate the change information generating device 300. In this case, the change process requiring the temporary information cannot be carried out, with the result that the process of reading out the temporary information in S402 is not carried out.

In the case where the change information is acquired in the offline manner, there may be carried out such control that the acquisition of the change information by the change information acquiring section 23 of the digital television 100 triggers automatic combining of the change information with the content that is currently being reproduced. In this case, the content ID of the content to be combined with the change information is caused to be contained in the change information such that the content to be combined can be specified, the content ID is extracted by the change information acquiring section 23, and a combining target specifying section (not shown) for specifying the combining target is further provided in the digital television 100. With this, the target content can be customized even the user does not operate the operation section 5.

Meanwhile, as with hardware configuration for acquiring the content, there are two types of hardware configuration of the acquiring means for acquiring the change information: (i) a hardware configuration for use in acquiring the change information in the online manner, and (ii) a hardware configuration for use in acquiring the change information in the offline manner.

In the case of acquiring the change information in the online manner, the communication section 3 (or the broadcasting receiving section 2) acquires the change information as a result of transmission of the change information request message to the change information generating device 300. The communication between the digital television 100 and the change information generating device 300 may be carried out in accordance with any communication method as long as two-way communication can be carried out. Thus, the acquiring means for acquiring the change information is constituted by a communication module that can use, e.g., a wired network or wireless network using the Internet, a mobile phone network, an infrared communication, and a near field wireless communication.

In the case of acquiring the change information in the offline manner, a small capacity semiconductor memory card reading/writing module, a two-dimensional barcode scanning module, or the like can be used for the external interface section 4. However, in the case of acquiring the change information in the offline manner, a request message transmitting section (not shown) needs to be further provided in the digital television 100 so as to transmit the change information request message to the change information generating device 300. An example of acquiring the change information in the offline manner is as follows. That is, in response to a user's operation on an information kiosk terminal for making a request for change information, the change information is recorded onto a memory card or is issued in the form of two-dimensional barcode display. Alternatively, a plurality of cards each storing one change information are prepared in consideration of combinations of change information that can be combined together, and the user selects and purchases, at a shop, cards storing change information corresponding to changes that the user desires.

Finally, as an example of application of the content processing device (digital television 100) of the present invention, the following explains a case where the content processing device is applied to a mobile phone (content processing device) provided with a digital television tuner. That is, the digital television tuner of the mobile phone serves as the broadcasting receiving section 2.

The mobile phone is capable of acquiring, via a digital television broadcasting wave, the content 50 including the plurality of medium objects. Further, the mobile phone is provided with a change information acquiring section 23 using the mobile phone network. Therefore, the aforementioned change information can be acquired in such a mobile environment.

Further, the mobile phone network is inferior to the wired broadband communication network in terms of communication speed and bandwidth (the number of terminals that a base station can deal with), and data communication cost required in using the mobile phone network is higher as compared with data communication cost required in using the wired broadband communication network. Therefore, in the case of using the mobile phone network, it is greatly beneficial to acquire the change information as complementary information for the required and reproduced content.

Further, the mobile phone may have (i) a communication function for receiving a PUSH type information providing service available only in a limited distribution region; (ii) a function of a camera serving as a change information obtaining means (not shown) for obtaining the change information by scanning the two-dimensional barcode; or (iii) an infrared communication function. With this, the content processing device can be used in the mobile environment. This makes it possible to provide, to users who visit a shop or an event site, change information by which only the users are allowed to reproduce certain medium data.

Development of content creating techniques, of database techniques, and of mobile devices such as a mobile phone provided with a television tuner multiplies, year by year, the number of contents that users can acquire. This results in diversification of users' preferences to the contents.

According to the above content distribution system using the mobile phone network and including the mobile phone, it is possible to construct a content distribution system that accommodates to the diverse preferences of the users, without increasing (i) loads on communication lines of the mobile phone network and (ii) communication cost.

In the above embodiments, the digital television 100 is so arranged as to receive the content via the broadcasting wave and to acquire the change information via the communication network (or in the offline manner, i.e., from a storage medium or the like); however, the present invention is not limited to this. For example, the digital television 100 may be so arranged as to acquire the content via the communication network (mobile phone network) and to acquire the change information in the offline manner. Alternatively, the digital television 100 may be so arranged as to acquire the content from a one-way multicast type network and to acquire the change information from a two-way type network.

The present invention is not limited to the description of the embodiments above, but may be altered by a skilled person within the scope of the claims. An embodiment based on a proper combination of technical means disclosed in different embodiments is encompassed in the technical scope of the present invention.

Finally, each of the blocks of the digital television 100 (or the mobile phone provided with the television tuner), especially the content managing section 21, the change pattern list generating section 22, the change information acquiring section 23, the change information combining section 24, and the content reproducing section 25, may be constituted by hardware logic or may be constituted by software with the use of a CPU as follows.

That is, the digital television 100 includes (i) a CPU (central processing unit) for executing instructions of a control program realizing each function; (ii) a ROM (read only memory) storing the above program; (iii) a RAM (random access memory) for expanding the program; (iv) a storage device (storage medium), such as a memory, storing the program and various types of data; and the like. Therefore, the object of the present invention is achieved by: (i) providing, in the digital television 100, a storage medium which stores a computer-readable program code (executable program, intermediate code program, a source program) of the control program of the digital television 100 that is software for realizing the function, and (ii) causing a computer (CPU, or MPU) to read out and execute the program code stored in the storage medium.

Examples of the storage medium are: tapes such as a magnetic tape and a cassette tape; magnetic disks such as a floppy® disk and a hard disk; disks such as a CD-ROM (compact disk read only memory), a magnetic optical disk (MO), a mini disk (MD), a digital video disk (DVD), and a CD-Recordable (CD-R); and the like. Further, the storage medium may be: a card such as an IC card or an optical card; or a semiconductor memory such as a mask ROM, an EPROM (electrically programmable read only memory), EEPROM (electrically erasable programmable read only memory), or a flash ROM.

Further, the digital television 100 may be so arranged as to be connectable to a communication network, and the program code may be supplied to the digital television via the network. The communication network is not particularly limited. Specific examples thereof are: the Internet, intranet, extranet, LAN (local area network), ISDN (integrated services digital network), VAN (value added network), CATV (cable TV) communication network, virtual private network, telephone network, mobile communication network, satellite communication network, and the like. Further, a transmission medium (channel) constituting the communication network is not particularly limited. Specific examples thereof are: (i) a wired channel using an IEEE1394, a USB (universal serial bus), a power-line communication, a cable TV line, a telephone line, a ADSL line, or the like; or (ii) a wireless channel using IrDA, infrared rays used for a remote controller, Bluetooth®, IEEE802.11, HDR (High Data Rate), a mobile phone network, a satellite connection, a terrestrial digital network, or the like. Note that the present invention can be realized by a form of a computer data signal (a series of data signals) embedded in a carrier wave realized by electronic transmission of the program code.

Note that it is preferable to arrange the content processing device according to the present invention such that: the reproduction object at least includes either one of (i) a medium object including medium data that is a reproduction target, and (ii) a presentation object defining a procedure of reproducing the medium data.

This makes it possible to change (i) the medium data, which is a reproduction target and is included in the reproduction object, of the original content, and (ii) a way of reproducing the medium data.

For example, think that the presentation object defines a reproduction procedure of “displaying video medium data A fully on the display screen of the display section”. If the change information defines a procedure of changing the reproduction procedure of the presentation object such that “the video medium data A is to be displayed on the upper half portion of the display screen of the display section”, the change information combining section 24 customizes, in accordance with the change information thus acquired, (i) the content in which the video medium data A is designated to be displayed fully on the display screen of the display screen into (ii) a content in which the video medium data A is designated to be displayed on the upper half portion of the display screen of the display section.

Consider another example. Think that the medium object includes medium data A. If the change information defines a procedure of changing the medium object such that the medium data A is to be replaced with medium data A′, the change information combining section 24 customizes, in accordance with the change information thus acquired, the content into a content in which the medium data A′ is designated to be reproduced, instead of the medium data A, unlike in the original content.

Further, it is preferable that: the change information be able to include (i) information for specifying, as a change target, either a part of the reproduction object or an entire part of the reproduction object, and (ii) information indicating a material that is going to replace the change target, and in cases where the change information specifies a part of the reproduction object as the change target, the change information combining means 24 replace (i) the change target specified by the change information with (ii) the material indicated by the change information.

The case where the change information specifies a part of the reproduction object as the change target refers to a case where the change information merely specifies a part different between the original content and the customized content. Specifically speaking, for example, in the aforementioned case, the change information may define a procedure of replacing the reproduction procedure of “displaying fully on the display screen” with a reproduction procedure of “displaying on the upper half portion of the display screen”. As an alternative example, instead of replacing the medium data A with the medium data A′, the change information may define that only a part different between the medium data A and the medium data A′ is going to be replaced.

In these cases, the change information merely includes the information that specifies the difference between the original content and the customized content, so that the information amount of the change information is further reduced.

This makes it possible to restrain either loads on communication lines or communication cost, and to provide a customized content that meets diverse needs of a user.

Note that, the presentation object may include reproducing control information that defines whether or not the medium data of the medium object is to be reproduced.

This makes it possible to control reproducing/non-reproducing of the one or more medium data included in the content, thereby customizing the content.

For example, consider a case where the change information defines such a change procedure as to change reproducing control information for medium data B such that the reproducing control information indicates that “the medium data B is going to be reproduced” instead of indicating that “the medium data B is not going to be reproduced”. This allows the change information combining section 24 to customize (i) the content in which the medium data is designated so as not to be reproduced, into (ii) a content in which the medium data B is designated so as to be reproduced.

The content processing device may further include: a reproducing reference medium ID calculating section 21b (ID converting means) for generating, by using (i) a first medium ID originally given to the medium object so as to identify the medium object and (ii) a random number, a second medium ID that indicates a storage location of the medium object to be reproduced and that is given to the medium object; and a content managing section 21 (content managing means) for recording the medium object onto a content storage section in accordance with the second medium ID.

According to the above structure, the reproducing reference medium ID calculating section 21b uses (i) the first medium ID given to the medium object and (ii) the random number, so as to generate the second medium ID for the medium object. The second medium ID is information indicating where in the content storage section the medium object is going to be recorded. Then, the content managing section 21 records the medium object onto the storage location of the content storage section as indicated by the second medium ID thus generated.

Accordingly, for readout of the desired medium object from the content storage section 41 on reproducing the medium content, it is necessary to make reference to the second medium ID, not the first medium ID originally given thereto.

As such, the random number is used to generate the second medium ID such that it is difficult to conceive the second medium ID, and the second medium ID thus generated is used as reference information used in reading out the medium object. This makes it possible to prevent the user from maliciously extracting the medium object.

Accordingly, a user having no right of using the medium object is prevented from illegally using the medium content with ease. Further, the stored content is less likely to be distributed without permission.

A concrete example of the way of generating the second medium ID is to use the one-way function. For example, the first medium ID and the random number are combined, and are inputted into a hash value calculation function. The first medium ID and the random number are combined by (i) putting the random number after the first medium ID, (ii) putting the first medium ID after the random number, or (iii) finding a logical product or logical sum of bit sequences of the first medium ID and the random number.

The second medium ID thus generated by applying the one-way function to the value found by the combining is a value that is so completely different from the first medium ID that it is impossible to conceive it from the first medium ID with ease. This makes it possible to prevent illegal use of the medium object.

Further, it is preferable that the change information acquiring section 23 make reference to change history information which records, for each content, history of change information having been used before by the change information combining section 24 in order to change the reproduction object, so as to acquire the change information correlated with the content and having been used before.

According to the above structure, for example, when a change pattern D is designated when reproducing a certain content, the change information acquiring section 23 makes reference to the change history information before acquiring change information D corresponding to the change pattern D. If there is a record that change information A to C have been applied to the content and the content has been reproduced, the change information acquiring section 23 acquires the change information A to C in addition to the change information D.

This makes it easy to automatically apply the previous change information in the case of acquiring, in addition to the new change information, the change information having been applied before. Accordingly, the user does not need to always operate to designate the customizing having been designated in the past, all over again. This improves operationality for the user.

It is preferable that: the change information be given a group identifier for use in classifying change information into groups, only one change information being selected from each group so as to be applied to a reproduction object of one content, and the change information combining section 24 use only change information having different group identifiers, so as to change a reproduction object of one content.

Some change information cannot be applied to one content (or medium object) at the same time. In the case of providing such selective change pattern variations, the change information are classified into groups and the change information belonging to the same group are given the same group identifier. This makes it possible to carry out such a customizing process that the change information having the same group identifier are prevented from being applied to the content at the same time.

Further, the change information generating device may be arranged such that: the change information generating section 301 generates the change information requested by the content processing device, by replacing (i) the first medium ID included in the change information definition file with (ii) the second medium ID.

In this case, the described reference location (i.e., storage location) of the medium object in the change information definition file serving as a template, i.e., the medium object specified as a medium object to be reproduced is rewritten so as to coincide with the actual storage location of the medium content in the content storage section of the content processing device, with the result that the change information is obtained based on the change information definition file.

That is, the change information generating means replaces (i) the first medium ID described in the change information definition file with (ii) the calculated second medium ID, thereby generating the change information requested by way of the request message.

This makes it possible to simplify the process of generating the change information, with the result that the process of supplying the change information requested by the content processing device becomes efficient.

Note that each of the content processing device and the change information generating device may be realized by a computer. In this case, the present invention encompasses (i) a control program for controlling the content processing device (or the change information generating device), which control program realizes the content processing device (or the change information generating device) in a computer by causing the computer to operate as the aforementioned means; and (ii) a computer-readable storage medium storing the control program.

The content processing device of the present invention is applicable to a television, a set top box, a home server, a hard disk recorder, a PC (personal computer), a PDA (personal digital assistant), a mobile phone, a mobile audio device, a car navigation equipment, and the like.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. A content processing device for processing received contents, each of which includes a reproduction object including information required for reproducing the content,
said content processing device, comprising:
a change pattern list generating means for generating change pattern list information representing a list of change patterns applicable to the reproduction object, in accordance with change pattern information indicating the change patterns;
change information acquiring means for acquiring, from a change information storage section storing change information, change information that defines a change procedure of changing the reproduction object and that corresponds to a change pattern designated by a user from the change patterns included in the change pattern list information; and
change means for changing the reproduction object in accordance with the change procedure defined by the change information acquired by the change information acquiring means.

2. The content processing device as set forth in claim 1, wherein:
the reproduction object at least includes either one of (i) a medium object including medium data that is a reproduction target, and (ii) a presentation object defining a procedure of reproducing the medium data.

3. The content processing device as set forth in claim 2, wherein:
the change information is able to include (i) information for specifying, as a change target, either a part of the reproduction object or an entire part of the reproduction object, and (ii) information indicating a material that is going to replace the change target, and
in cases where the change information specifies a part of the reproduction object as the change target, the change means replaces (i) the change target specified by the change information with (ii) the material indicated by the change information.

4. The content processing device as set forth in claim 2, wherein:
the presentation object includes reproducing control information that defines whether or not the medium data of the medium object is to be reproduced.

5. The content processing device as set forth in claim 2, further comprising:
ID converting means for generating, by using (i) a first medium ID originally given to the medium object so as to identify the medium object and (ii) a random number, a second medium ID that indicates a storage location of the medium object to be reproduced and that is given to the medium object; and
content managing means for recording the medium object onto a content storage section in accordance with the second medium ID.

6. The content processing device as set forth in claim 1, wherein:
the change information acquiring means makes reference to change history information which records, for each content, history of change information having been used before by the change means in order to change the reproduction object, so as to acquire the change information correlated with the content and having been used before.

7. The content processing device as set forth in claim 1, wherein:
the change information is given a group identifier for use in classifying change information into groups, only one change information being selected from each group so as to be applied to a reproduction object of one content, and
the change means uses only change information having different group identifiers, so as to change a reproduction object of one content.

8. A change information generating device for generating the change information to be supplied to the content processing device as set forth in claim 5, in response to a request message that is transmitted from the content processing device so as to request the change information and that includes (i) a change information ID specifying the change information requested by the content processing device and (ii) the random number generated by the content processing device and correlated with the change information,
said change information generating device, comprising:
a definition file database for storing a change information definition file, which defines the change information, such that the change information definition file is correlated with the change information ID;
ID converting means for extracting, from the definition file database, the change information definition file correlated with the change information ID included in the request message, and for generating the second medium ID in the change definition file by using (i) the first medium ID that specifies the medium object to be reproduced and (ii) the random number included in the request message; and
change information generating means for generating, as the requested change information, the change information for specifying, in accordance with the second medium ID generated by the ID converting means, the storage location of the medium object to be reproduced.

9. The change information generating device as set forth in claim 8, wherein:
the change information generating means generates the change information requested by the content processing device, by replacing (i) the first medium ID included in the change information definition file with (ii) the second medium ID.

10. A method for processing received contents, each of which includes a reproduction object including information required for reproducing the content,
said method, comprising:
a first step of generating change pattern list information representing a list of change patterns applicable to the reproduction object, in accordance with change pattern information indicating the change patterns;
a second step of acquiring, from a change information storage section storing change information, change information that defines a change procedure of changing the reproduction object, and that corresponds to a change pattern designated by a user from the change patterns included in the change pattern list information; and
a third step of changing the reproduction object in accordance with the change procedure defined by the change information acquired in the second step.

11. A method for generating the change information to be supplied to the content processing device as set forth in claim 5, in response to a request message that is transmitted from the content processing device so as to request the change information and that includes (i) a change information ID specifying the change information requested by the content processing device and (ii) the random number generated by the content processing device and correlated with the change information,
said method, comprising:
a first step of extracting a change information definition file that defines the change information and that is so stored in a definition file database as to be correlated with the change information ID included in the request message, and of generating the second medium ID in the change definition file by using (i) the first medium ID that specifies the medium object to be reproduced and (ii) the random number included in the request message; and
a second step of generating, as the requested change information, the change information for specifying, in accordance with the second medium ID generated by the ID converting means, the storage location of the medium object to be reproduced.

12. A program for controlling a content processing device for processing received contents, each of which includes a reproduction object including information required for reproducing the content,
said program, causing a computer to execute:
a first step of generating change pattern list information representing a list of change patterns applicable to the reproduction object, in accordance with change pattern information indicating the change patterns;
a second step of acquiring, from a change information storage section storing change information, change information that defines a change procedure of changing the reproduction object, and that corresponds to a change pattern designated by a user from the change patterns included in the change pattern list information; and
a third step of changing the reproduction object in accordance with the change procedure defined by the change information acquired in the second step.

13. A program for controlling a change information generating device for generating the change information to be supplied to the content processing device as set forth in claim 5, in response to a request message that is transmitted from the content processing device so as to request the change information and that includes (i) a change information ID specifying the change information requested by the content processing device and (ii) the random number generated by the content processing device and correlated with the change information,
said program, causing a computer to execute:
a first step of extracting a change information definition file that defines the change information and that is so stored in a definition file database as to be correlated with the change information ID included in the request message, and of generating the second medium ID in the change definition file by using (i) the first medium ID that specifies the medium object to be reproduced and (ii) the random number included in the request message; and
a second step of generating, as the requested change information, the change information for specifying, in accordance with the second medium ID generated by the ID converting means, the storage location of the medium object to be reproduced.

14. A computer-readable storage medium for storing the program as set forth in claim 12.

15. A computer-readable storage medium for storing the program as set forth in claim 13.
